(19) United States
(12) Patent Application Publication
(10) Pub. No.: US 2023/0178022 A1
(43) Pub. Date: Jun. 8, 2023

(54) DISPLAY DEVICE AND CONTROL METHOD THEREFOR

(71) Applicant: WUHAN TIANMA MICRO-ELECTRONICS CO., LTD., Wuhan (CN)

(72) Inventors: Nobuya SEKO, Kanagawa (JP); Shigeru MORI, Kanagawa (JP)

(21) Appl. No.: 18/074,822

(22) Filed: Dec. 5, 2022

(30) Foreign Application Priority Data
Dec. 8, 2021 (JP) 2021-199125
Sep. 12, 2022 (JP) 2022-144584

(51) Int. Cl. G09G 3/3233

(52) U.S. Cl. CPC G09G 3/3233; G09G 2360/147; G09G 2360/16; G09G 2320/041; G09G 2300/0861; G09G 2320/045; G09G 2320/0233; G09G 2320/046; G09G 2300/0842; G09G 2310/08

(57) ABSTRACT

A display device includes a display panel including a plurality of pixels arrayed on a substrate, a photosensor, and a control device including a lock-in amplifier. Each of the plurality of pixels includes a light-emitting element. The control device is configured to select one or more pixels from the plurality of pixels, perform measurement of a light intensity of the one or more pixels, and control light emission of the one or more pixels based on a result of the measurement. The measurement includes applying alternating modulation to light emission of the selected one or more pixels, and measuring a light detection signal generated by the photodetector in response to light from the selected one or more pixels with the lock-in amplifier based on a reference signal synchronized with the alternating modulation.

### CROSS-REFERENCE TO RELATED APPLICATIONS

This non-provisional application claims priority under 35 U.S.C. § 119(a) on Patent Application No. 2021-199125 filed in Japan on Dec. 8, 2021 and Patent Application No. 2022-144584 filed in Japan on Sep. 12, 2022, the entire contents of which are hereby incorporated by reference.

### BACKGROUND

This disclosure relates to a display device and a control method therefor.

Organic light-emitting diode (OLED) display devices are replacing liquid crystal display devices. An OLED element that produces display of the OLED display device is a self-light-emitting device and therefore, it suffers from irreversible change in current-voltage-light intensity characteristic that affects its lighting life. This characteristic change appears largely when the current for lighting the OLED element is high for high-intensity display and the duration of lighting the OLED element is long.

When the characteristic change occurs uniformly in the whole display screen, the change appears as reduction in average brightness of a whole display. However, after a fixed pattern is displayed for a long time, characteristic change corresponding to the pattern occurs. Accordingly, a problem of so-called image burn-in or an afterimage, where a trace of the fixed pattern is persistently seen, occurs. To solve or mitigate this problem, there is an approach called deterioration compensation, which determines the degrees of deterioration of individual pixels caused by the load accumulated by lighting and alters the lighting conditions of the pixels depending on their degrees of deterioration to avoid degradation of display quality.

### SUMMARY

An aspect of this disclosure is a display device including: a display panel including a plurality of pixels arrayed on a substrate; a photosensor; and a control device including a lock-in amplifier. Each of the plurality of pixels includes a light-emitting element. The control device is configured to: select one or more pixels from the plurality of pixels; perform measurement of a light intensity of the one or more pixels; and control light emission of the one or more pixels based on a result of the measurement. The measurement includes: applying alternating modulation to light emission of the selected one or more pixels; and measuring a light detection signal generated by the photodetector in response to light from the selected one or more pixels with the lock-in amplifier based on a reference signal synchronized with the alternating modulation.

An aspect of this disclosure is a method of controlling a display device including: selecting one or more pixels from a plurality of pixels; measuring a light intensity of the one or more pixels; and controlling light emission of the one or more pixels based on a result of the measurement. The measuring includes: applying alternating modulation to light emission of the selected one or more pixels; and performing lock-in measurement on the modulated light from the selected one or more pixels based on a reference signal synchronized with the alternating modulation.

It is to be understood that both the foregoing general description and the following detailed description are exemplary and explanatory and are not restrictive of this disclosure.

### BRIEF DESCRIPTION OF THE DRAWINGS

FIG. 1 schematically illustrates a configuration example of a display device in an embodiment of this specification;

FIG. 2 schematically illustrates the position of a photosensor with respect to a display panel including a display region;

FIG. 3 illustrates a configuration example of a lock-in amplifier;

FIG. 4 illustrates an example of information stored in a storage circuit;

FIG. 5 illustrates a configuration example of light intensity temperature compensation information;

FIG. 6 illustrates a configuration example of photosensor sensitivity temperature compensation information;

FIG. 7 illustrates a configuration example of light intensity conversion information;

FIG. 8 illustrates examples of outputs of a photosensor;

FIG. 9 illustrates relations between the intensity of light going out to the front of the display region when an OLED element emits light under different temperatures and the emission level according to image data;

FIG. 10 illustrates relations between the output of the photosensor under different temperatures in response to light emission of an OLED element and the emission level according to image data;

FIG. 11 schematically illustrates examples of variation of estimated frontal light intensity of an OLED element under actual use environment of an OLED display device;

FIG. 12 illustrates an example of a desired characteristic, in addition to the estimated frontal light intensities in FIG. 11;

FIG. 13 is a flowchart of deterioration evaluation on the OLED elements in a display region and display adjustment;

FIG. 14 is a conceptual diagram of intermittently acquiring display compensation information for the entire display region;

FIG. 15 provides examples of outputs of the photosensor attached on a side end face of the display panel in response to different kinds of light;

FIG. 16 provides examples of the results of lock-in measurement when different numbers of display pixels are lit;

FIG. 17 illustrates an example of a plurality of photosensors attached on side end faces of a display panel;

FIG. 18 illustrates an example of an optical waveguide for guiding the light leaking from the end faces of a display panel to a photosensor;

FIG. 19 illustrates an example of an under-display camera configuration;

FIG. 20 illustrates a configuration example of an OLED display device that utilizes frame rewriting operation to make an OLED element blink;

FIG. 21 illustrates a configuration example for conducting measurement before shipment;

FIG. 22 provides an example of the measurement results on leaking light when the RGB emission levels are changed;

FIG. 23 illustrates a configuration example of a pixel circuit;

FIG. 24 is a timing chart of the signals for controlling the pixel circuit in FIG. 23 in one frame period under normal image data displaying operation;

FIG. 25 illustrates an example of temporal variation of the emission control signal for one pixel row (horizontal line) in blinking control for deterioration evaluation;

FIG. 26 illustrates emission control signals for individual pixel rows at different times in displaying normal image data; and

FIG. 27 illustrates emission control signals for individual pixel rows at different times in blinking control for deterioration evaluation.

### EMBODIMENTS

Hereinafter, embodiments of this disclosure will be described with reference to the accompanying drawings. It should be noted that the embodiments are merely examples to implement this disclosure and not to limit the technical scope of this disclosure.

### Overview

Embodiments of a display device that displays an image with self-light-emitting elements are described. An example of the self-light-emitting element is an organic light-emitting diode (OLED) element. The features of this disclosure are applicable to display devices including self-light-emitting elements of the kinds different from OLED element. The following description refers to self-light-emitting element simply as light-emitting element.

A light-emitting element changes in its current-voltage-light intensity characteristic with duration of use. The intensity of light of a light-emitting element under the same driving conditions usually tends to decrease and therefore, the change is often referred to as deterioration. The display device in an embodiment of this specification evaluates the degree of deterioration of a light-emitting element by measuring the intensity of light emitted therefrom. The display device controls the emission of the light-emitting element based on the degree of deterioration of the light-emitting element. Thus, the display device can mitigate the degradation of its display quality.

The display device displays an image in its display region. The display region is composed of a plurality of pixels each including a light-emitting element. A pixel is the smallest unit to be controlled in light emission and can also be referred to as subpixel in a configuration to display a colored image. The pixels included in the display region may light in the same color, for example white, or in different colors, for example, red, green, and blue.

The display device evaluates the degree of deterioration of a light-emitting element by measuring the intensity of light emitted from the light-emitting element. The actual use environment of the display device includes external light such as sunlight and light emitted from various illumination devices. The intensity of the external light changes largely to affect the measurement of the intensity of light emitted from a light-emitting element. A display device in an embodiment of this specification performs lock-in measurement to measure the intensity of light emitted from a light-emitting element.

In an embodiment of this specification, the display device selectively lights a part of the pixels (light-emitting elements) included in the display region for measurement. The part of the pixels consists of one or more pixels. The display device applies alternating modulation at a specific frequency to the lighting of the selected pixels. Pulse modulation is a kind of alternating modulation. Other than a pulse signal, a sine wave can also be employed. A photosensor outputs a detection signal in accordance with the intensity of light including the alternating modulated light of the pixels. The lock-in amplifier extracts the component corresponding to the alternating modulated light of the pixels based on a reference signal of the foregoing specific frequency input to the lock-in amplifier.

In an embodiment of this specification, the photosensor is disposed at a place other than the front of the display region. The photosensor can be attached on a side end face of the display panel including the display region. This disposition prevents the photosensor from affecting the design of the display device and also, in terms of the functionality, prevents the photosensor from interfering with the user viewing images. The photosensor senses light leaking from the side end face of the display panel. The leaking light is weaker than the display light going out from the display panel to the front of the display region.

The aforementioned lock-in measurement of the light from the selected pixels reduces the influence of external light to achieve appropriate measurement of leaking light originating from the light emitted from the selected pixels. The light emitted from the selected pixels in a specific area mostly goes out to the front of the display region as display light. However, a part of the light travels through inside the display panel and reaches the side end face of the display panel to become leaking light. The structure of the display panel does not change with duration of use; the location of the photosensor does not change after the display panel is manufactured.

Accordingly, the intensity of light emitted from a pixel and going out to the front of the display region and the intensity of light emitted from the pixel and reaching the photosensor via the inside of the display panel have a fixed relation depending on the coordinates of the selected pixel. If this relation is identified in advance, the intensity of light going out to the front of the display region can be estimated by measuring the leaking light with a photosensor.

### Device Configuration

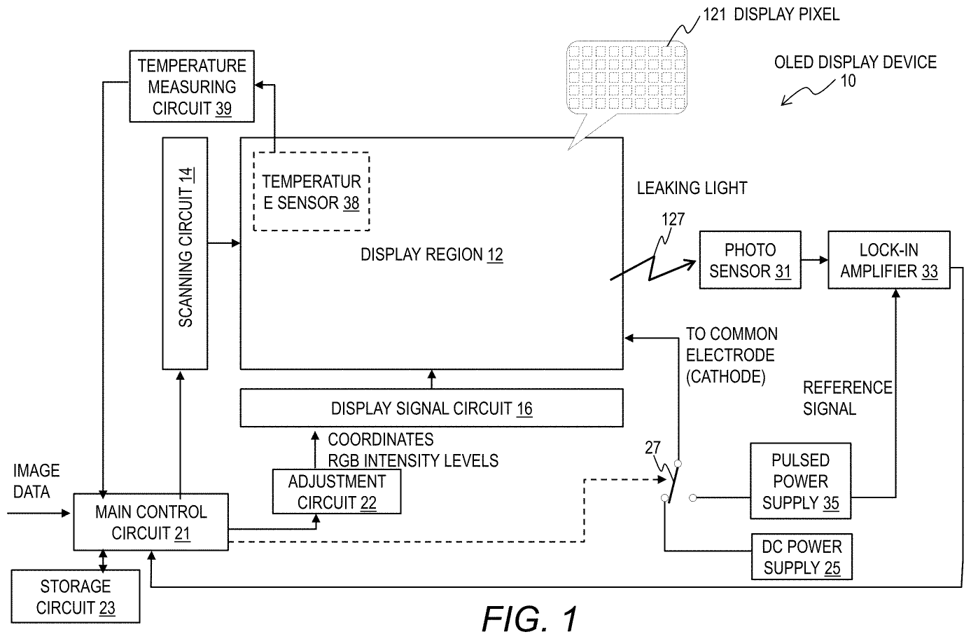

FIG. 1 schematically illustrates a configuration example of a display device in an embodiment of this specification. Although an OLED display device is described as an example of the display device, the features of this disclosure are applicable to display devices including other kinds of light-emitting elements.

A configuration example is described with reference to FIG. 1. The OLED display device 10 includes a display panel including a display region 12 and a control circuit for controlling the display panel. The control circuit includes a scanning circuit 14, a display signal circuit 16, a main control circuit 21, an adjustment circuit 22, a storage circuit 23, a switch 27, a lock-in amplifier 33, and a temperature measuring circuit 39. The OLED display device 10 further includes a lighting-power supply circuit including a DC power supply 25 and a pulsed power supply 35, a photosensor 31, and a temperature sensor 38.

The display region 12 includes a plurality of display pixels 121 that are arrayed planarly. Each display pixel 121 consists of one or more pixels. In the example described in the following, each pixel 121 consists of three pixels of a red pixel, a green pixel, and a blue pixel. The following description refers to each of these three colors of pixels as subpixel. In comparison to subpixel, a display pixel consisting of three colors of subpixels may be referred to as main pixel.

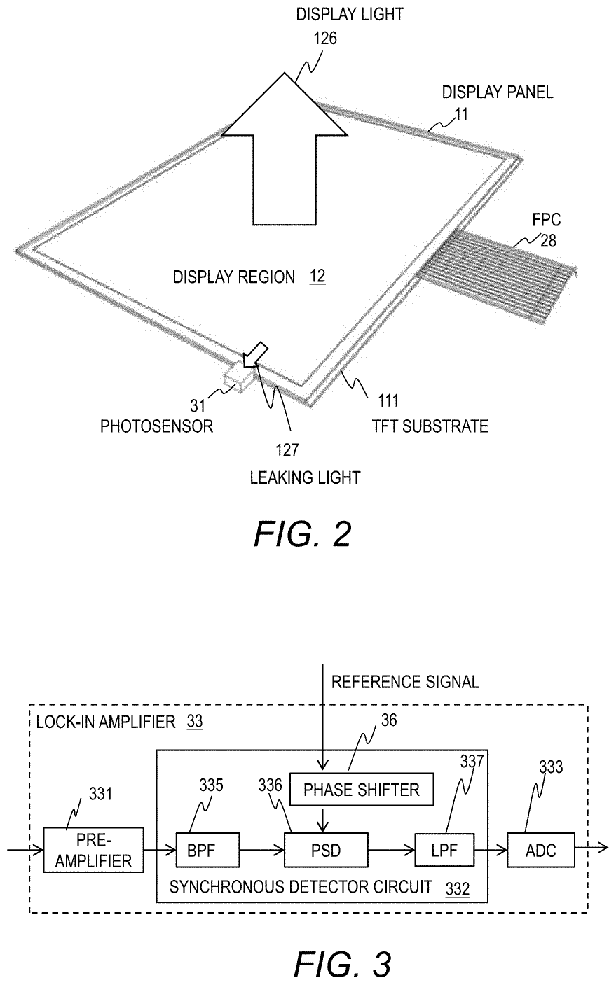

FIG. 2 schematically illustrates the position of the photosensor 31 with respect to the display panel 11 including the display region 12. The display panel 11 includes a thin-film transistor (TFT) substrate 111 on which OLED elements and pixel circuits are fabricated and a thin-film encapsulation (TFE) for encapsulating the OLED elements. Instead of the TFE, an encapsulation substrate can be bonded to the TFT substrate 111. The space between the TFT substrate and the encapsulation substrate can be filled with dry nitrogen, for example. Flexible printed circuits (FPC) are connected to the TFT substrate 111 to transmit data including image data between the control circuit on the TFT substrate 111 and external devices.

The photosensor 31 is disposed outside the display region 12 or at a place not in front of the display region 12. In the configuration example of FIG. 2, the photosensor 31 is attached on a side end face of the display panel 11. The light emitted from a subpixel or an OLED element mostly becomes display light 126 that goes out to the front of the display region 12 and in addition, a part of the emitted light enters a glass substrate or a translucent film substrate included in the display panel 11 and travels to a side end face of the display panel 11 to become leaking light 127 that goes out from the side end face.

Although the leaking light 127 in FIG. 2 is indicated at the place of the photosensor 31, it goes out from all side end faces and the back face of the display panel 11. Attaching the photosensor 31 on a side end face of the display panel 11 enables measurement of the intensity of light emitted from an OLED element without interfering with the visibility of the images during the normal image displaying operation or the design of the device.

Returning to FIG. 1, the description of the configuration example is continued. The control circuit and the power supply circuit are disposed outside the display region 12. For example, parts of the control circuit and the power supply circuit can be disposed in the peripheral area of the display region 12 on the TFT substrate 111. The other main control circuit 21, power supply circuit 25, and lock-in amplifier 33 can be disposed on the FPC 28 or a printed circuit board connected thereto to attain the configuration of FIG. 1. The configuration of FIG. 1 is connected to external devices to receive image data and a power supply voltage from the external devices. The disposition of the components can be different depending on the idea of the device design.

Display pixels are driven by so-called active matrix, which is performed by the scanning circuit and the display signal circuit cooperating under the control of the main control circuit. The scanning circuit 14 successively selects and drives the scanning lines and emission control lines on the TFT substrate 111 to control renewal of image data and emission period of each subpixel. The emission control lines can be regarded as scanning lines because they are used to select pixel circuit rows one by one. The scanning lines and the emission control lines are control lines for controlling pixel circuits. The main control circuit 21 supplies power and a timing signal (control signal) to the scanning circuit 14 and the scanning circuit 14 outputs scanning signals and emission control signals in accordance with the timing signal. A scanning signal is to select a pixel row where to write a display signal. An emission control signal is to switch on/off the supply of driving current to OLED elements to control whether to light the OLED elements.

The display signal circuit 16 supplies display signals to the data lines on the TFT substrate 111. The data lines transmit display signals to the pixel circuits in the pixel circuit row selected by the scanning circuit 14. Each pixel circuit supplies a driving current in accordance with the display signal to the OLED element and the OLED element lights at the intensity in accordance with the display signal.

Specifically, each pixel circuit includes a driving TFT (driving transistor) and a storage capacitor for retaining a signal voltage that determines the driving current of the driving TFT. The display signal transmitted by a data line is adjusted depending on the threshold of the driving TFT and stored to the storage capacitor. The voltage of the storage capacitor determines the gate voltage (Vgs) of the driving TFT. The display signal changes the conductance of the driving TFT in an analog manner to supply a forward bias current corresponding to an emission level to the OLED element.

The display signal circuit 16 outputs display signals in accordance with the display data supplied from the adjustment circuit 22. The main control circuit 21 provides the adjustment circuit 22 with parameters for compensating for the deterioration of individual subpixels. The adjustment circuit 22 receives the coordinates and the red, green, and blue intensity levels of each display pixel and generates display data from the red, green, and blue intensity levels in accordance with the compensation parameters.

The main control circuit 21 receives image data from the external and determines intensity levels (emission levels) of individual subpixels from each of successive image frames. The emission levels are forwarded to the adjustment circuit 22. As will be described later, the main control circuit 21 measures the intensities of light emitted from individual subpixels (OLED elements) in the display region 12 and evaluates the degrees of deterioration of the OLED elements. The main control circuit 21 determines a deterioration compensation parameter for each subpixel depending on the degree of deterioration of the OLED element therein and provides it to the adjustment circuit 22.

The storage circuit 23 stores control information for the main control circuit 21 to evaluate the deterioration of OLED elements and deterioration compensation parameters determined by the main control circuit 21. The details of the information stored in the storage circuit 23 will be described later.

The OLED display device 10 uses a temperature sensor 38 in addition to the photosensor 31 in deterioration evaluation of OLED elements. The temperature sensor 38 can be disposed behind the display region 12. Although FIG. 1 illustrates an example where the OLED display device 10 includes one temperature sensor 38, the OLED display device 10 can include a plurality of temperature sensors. The disposition of the temperature sensors is determined appropriately depending on the design. For example, a plurality of temperature sensors can be disposed at different locations behind the display region 12 and one of them can be disposed in the vicinity of the photosensor 31.

The temperature measuring circuit 39 receives a temperature sensing signal from the temperature sensor 38 and determines the temperature in the vicinity of the temperature sensor 38 from the temperature sensing signal. The temperature measuring circuit 39 supplies data on the determined temperature to the main control circuit 21. As will be described later, the main control circuit 21 applies temperature compensation to the sensitivity of the photosensor 31 and the light intensities of the OLED elements, based on the temperature measured by the temperature sensor 38.

In the case where the OLED display device 10 includes a plurality of temperature sensors, deterioration evaluation of an OLED element can use a temperature sensor associated with the photosensor and further, a temperature sensor associated with the OLED element to be evaluated. The temperature sensor associated with the photosensor or an OLED element can be the closest temperature sensor. A nearby temperature sensor enables more accurate temperature compensation.

The main control circuit 21 controls the switch 27 so that the DC power supply 25 is connected to a common electrode (cathode) of the display panel 11 during normal displaying operation. The DC power supply 25 supplies a predetermined constant potential to the common electrode. The common electrode is a single electrode shaped to cover the entire display region 12; a part of the common electrode works as the cathode of an OLED element.

For deterioration evaluation of OLED elements, the main control circuit 21 turns the switch 27 so that the pulsed power supply 35 is connected to the common electrode, instead of the DC power supply 25. The main control circuit 21 selects one or more subpixels (OLED elements) for measurement and writes display signals to them. The pulsed power supply 35 supplies the common electrode with cathode power supply potential periodically changing between an L-level and an H-level. As a result, pulse-modulated driving current is supplied to the OLED elements to modulate the lighting of the OLED elements. The function of the pulsed power supply 35 can also be implemented by repeatedly turning on and off the DC power supply 25 with a switching element such as an FET.

The frequency for the pulsed power supply can be selected to avoid influences of the other periodical signals. In the case of turning on and off the DC power supply, the same applies to the frequency to control the turning on and off. For example, the frequencies of expected noise sources, such as the utility power frequencies of 50 Hz and 60 Hz, the frequencies for fluorescent light inverters, and integral multiples of these frequencies, are to be excluded. As a result, less noise is generated and the accuracy in measurement increases. The frequency of the pulsed power supply can be higher than the frame frequency in the normal displaying operation of the OLED display device 10.

In many cases, the frame frequency is 60 Hz or 120 Hz at most. The noise in many systems has a tendency that frequency components of frequencies closer to 0 Hz are larger. Selecting a high frequency is to avoid such noise. Moreover, the pixels are turned off in rewriting data, which corresponds to blinking at the frame frequency. Taking the normal operation as a standard, the display panel in an embodiment of this specification modulates the voltage of the common cathode electrode during the operation of measuring light intensity.

That is to say, the frame frequency can be a noise for lock-in measurement. In lock-in measurement, the frequency of an input signal is converted by a synchronous detector circuit so that the modulating frequency component will become a component of 0 Hz (DC) and thereafter, unnecessary frequency components are removed by a lowpass filter (LPF), as will be described later.

In the frequency conversion, the noise frequency components are converted to keep certain differences from the modulating frequency. If the noise components are of frequencies close to the modulating frequency, the cut-off frequency has to be set low to remove the noise components. If the cut-off frequency of the LPF is low, the time constant becomes long; the measurement takes a long time.

Accordingly, in order to increase the efficiency of measurement by effectively separating the obviously existing noise components, it is effective to provide large differences between the modulating frequency and the frequencies of the noise components. The large frequency differences can be attained by setting a modulating frequency higher than the frame frequency. This configuration enables more appropriate measurement of light intensities of OLED elements.

The lighting of an OLED element is appropriately pulse-modulated substantially independently from the pixel circuit configuration by periodically changing the cathode power supply potential. The OLED element changes the intensity of light emitted therefrom like pulses in response to the pulse-modulated cathode power supply potential. The L-level cathode power supply potential can be equal to the potential supplied from the DC power supply 25 in normal operation.

In the period of the H-level cathode potential, the OLED element does not light, or its light intensity is zero. The OLED element repeats lighting at a specific intensity and complete non-lighting. However, the waveform of the light intensity under pulse modulation could be delayed because of the capacitance of the OLED element. The OLED element could light faintly because a potential difference caused by rounding of the waveform is applied to the OLED element during a period of the H-level cathode potential. Even in such a case, a modulating frequency can be selected so that the OLED element repeats lighting at a specific intensity and complete non-lighting.

Lock-in measurement provides an output based on the amplitude of an input. Accordingly, faint light emitted from an OLED element in a period where the OLED element is supposed not to light at all causes a negative error in the amount of the faint light to the measurement result. Accordingly, a potential higher than the anode potential of the OLED element is selected for the H-level potential. Then, the OLED element (subpixel) does not light at all (the emission intensity is 0) during the H-level period and can repeat lighting at a specific intensity and non-lighting. In the example described in the following, the OLED element blinks on and off for its deterioration evaluation.

The photosensor 31 detects light including leaking light originating from the blinking OLED element and sends a photodetection signal to the lock-in amplifier 33. The lock-in amplifier 33 receives a reference signal having a modulating frequency from the pulsed power supply 35, in addition to the photodetection signal from the photosensor 31. In the case of turning on and off the DC power supply, the control signal for turning on and off the DC power supply works as the reference signal.

The lock-in amplifier 33 extracts a component corresponding to the leaking light originating from the blinking OLED element from the photodetection signal based on the reference signal. Lock-in measurement as described above can measure the light intensity of the OLED element with high accuracy, avoiding the influence of a considerable amount of noise including external light.

FIG. 3 illustrates a configuration example of the lock-in amplifier 33. The lock-in amplifier 33 includes a pre-amplifier 331, a synchronous detector circuit 332, and an AD converter (ADC) 333. The pre-amplifier 331 amplifies a detection signal from the photosensor 31 to the amplitude appropriate to be processed by the lock-in amplifier 33.

The synchronous detector circuit 332 can detect a minute signal in noise with high sensitivity. The synchronous detector circuit 332 includes a bandpass filter (BPF) 335, a phase-sensitive detector (PSD) 336, a lowpass filter (LPF) 337, and a phase shifter 36.

As described above, the light from the OLED element is pulse-modulated. The detection signal of the photosensor 31 includes a signal corresponding to the light intensity of the OLED element that varies at the same frequency and the same phase as the modulating signal and various noise components including components of external light are superimposed on this signal. The bandpass filter 335 selectively passes the modulating frequency component and attenuates the other components. As a result, most of the noise components of different frequencies are removed. The bandpass filter can be replaced by a tuning amplifier.

The phase-sensitive detector (PSD) 336 rectifies the signal from the bandpass filter 335 synchronously with the reference signal (modulating signal). The phase shifter 36 adjusts the phase of the reference signal. Specifically, the phase shifter 36 adjusts the phase of the reference signal so that the phase of the reference signal is synchronized with the phase of the detection signal generated by the blinks of the OLED element in order to avoid the influence of the phase shifts of these signals occurring in the circuits on the way to the phase sensitive detector 336. The phase shifter 36 is optional. The phase sensitive detector 336 receives the reference signal where the phase difference generated on the way to the phase sensitive detector 336 is corrected by the phase shifter. The phase sensitive detector 336 performs full-wave rectification by switching the signal from the bandpass filter 335 based on the reference signal.

The lowpass filter (LPF) 337 extracts a DC component from the signal received from the phase sensitive detector 336 to generate a determinate measurement signal. Specifically, the full-wave rectified wave includes the signal component as a DC component but also include components different in phase or components of frequencies different from the modulating frequency as AC components. Passing this signal through the lowpass filter has the same effect as time-averaging; the AC components are canceled. Components different from the reference signal in phase or frequency can be thus removed.

Even if a noise caused by strong external light is included in the photodetection signal of the photosensor 31, the noise can be eliminated through the above-described process because the external light is not pulse-modulated for measurement. As described above, the synchronous detector circuit 332 can extract the component having the same frequency and phase as the blinks of an OLED element with high sensitivity. The output from the synchronous detector circuit 332 is converted by the AD converter 333 into a digital signal and forwarded to the main control circuit 21.

The lock-in amplifier does not need to have the above-described configuration; a two-phase lock-in amplifier that uses two reference signals having a phase difference of 90° or an analog multiplying circuit can replace it. Any configuration can be used that is able to extract a component having the same frequency and the same cycle as the pulsed light of an OLED element from the photodetection signal of the photosensor 31.

### Control Information

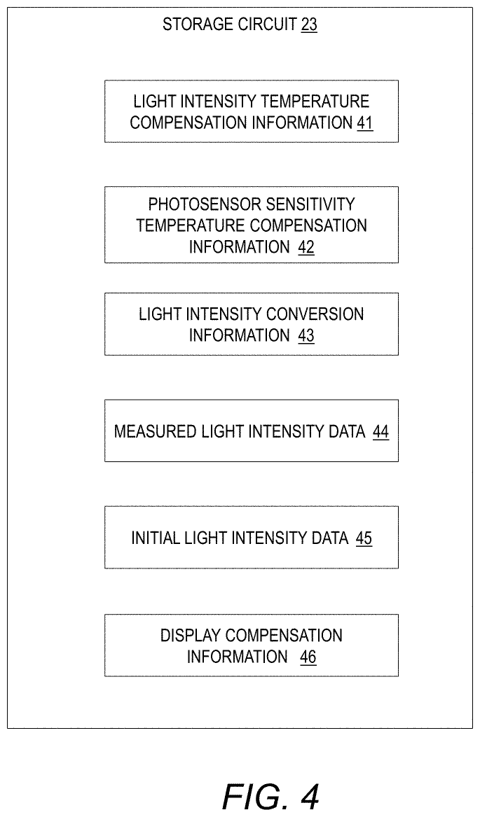

FIG. 4 illustrates an example of information stored in the storage circuit 23. An example of the storage circuit 23 is an electrically erasable programmable read-only memory (EEPROM). Usually, a non-volatile memory is used for the storage circuit 23. The storage circuit 23 stores light intensity temperature compensation information 41, photosensor sensitivity temperature compensation information 42, light intensity conversion information 43, measured light intensity data 44, initial light intensity data 45, and display compensation information 46.

The light intensity temperature compensation information 41 is information to be used to apply temperature compensation to the light intensity of an OLED element. The photosensor sensitivity temperature compensation information 42 is information to be used to apply temperature compensation to the photosensor sensitivity. The light intensity conversion information 43 is information to be used to convert the intensity of leaking light detected by the photosensor into the intensity of light going out to the front of the display region. The light intensity temperature compensation information 41, the photosensor sensitivity temperature compensation information 42, and the light intensity conversion information 43 are stored in the storage circuit 23 in advance and referenced in deterioration evaluation of OLED elements.

The measured light intensity data 44 is data on the light intensities measured in deterioration evaluation of OLED elements. The initial light intensity data 45 is data on the light intensities of OLED elements measured before the practical use of the OLED display device 10. The display compensation information 46 is generated based on the results of deterioration evaluation of the OLED elements and referenced to perform deterioration compensation.

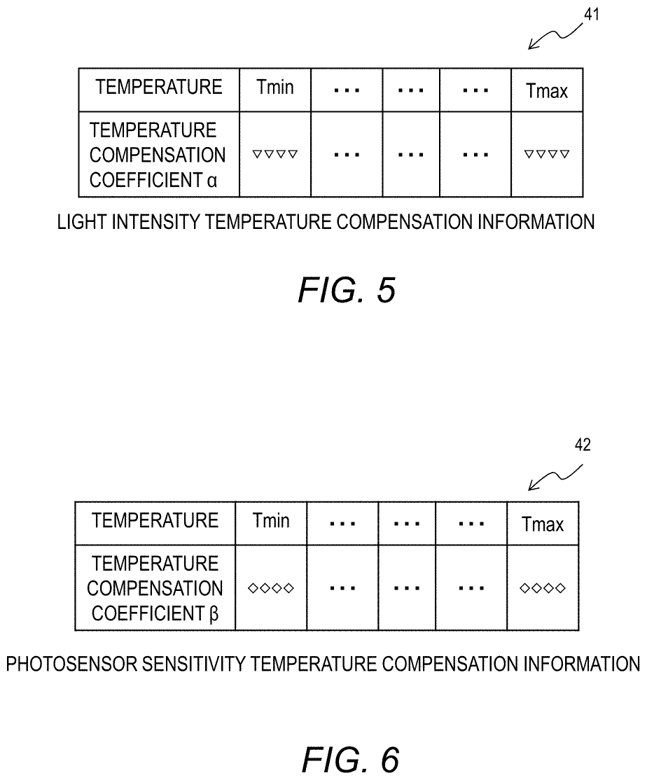

FIG. 5 illustrates a configuration example of the light intensity temperature compensation information 41. The light intensity temperature compensation information 41 provides relations between a temperature and a temperature compensation coefficient α. Multiplying the light intensity of an OLED element at a temperature by the temperature compensation coefficient α associated with the temperature provides the intensity of light emitted at a standard temperature. Although FIG. 5 provides the relations between a temperature and a temperature compensation coefficient α in a table format, these relations can be expressed by a function formula.

FIG. 6 illustrates a configuration example of the photosensor sensitivity temperature compensation information 42. The photosensor sensitivity temperature compensation information 42 provides relations between a temperature and a temperature compensation coefficient β. Multiplying a detection signal of the photosensor at a temperature by the temperature compensation coefficient β associated with the temperature provides a detection signal under the photosensor sensitivity at a standard temperature. Although FIG. 6 provides the relations between a temperature and a temperature compensation coefficient β in a table format, these relations can be expressed by a function formula.

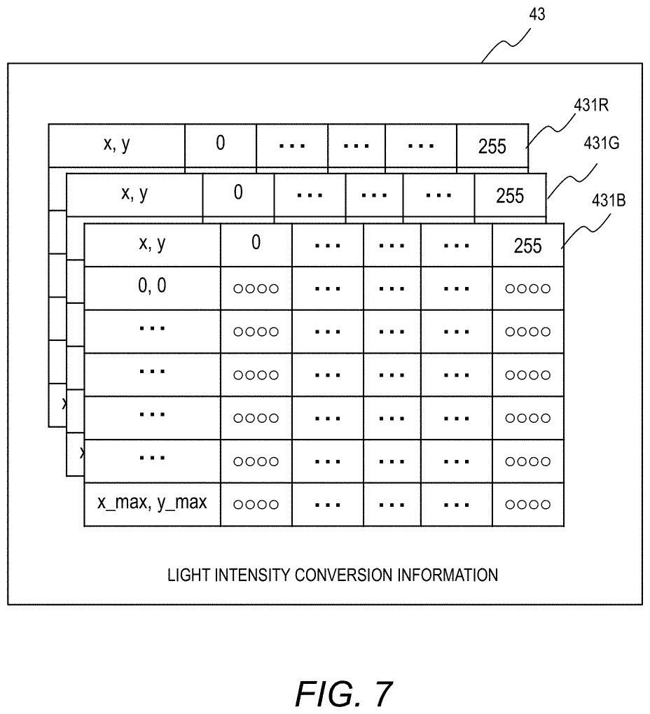

FIG. 7 illustrates a configuration example of the light intensity conversion information 43. The light intensity conversion information 43 includes tables 431R, 431G, and 431B for red subpixels, green subpixels, and blue subpixels, respectively. Each table provides coefficients for converting the intensity of leaking light measured by the photosensor into the intensity of light going out to the front of the display region. Specifically, each table provides coefficients for individual combinations of location coordinates of a display pixel and an emission level. The coefficients can be defined only for the location coordinates, without depending on the emission level. In still another example, the coefficients can be provided for combinations of location coordinates of a display pixel and a light intensity level detected by the photosensor, instead of an emission level.

The positional relations between the photosensor 31 attached on the side end face of the display panel and a subpixel (OLED element) are different depending on the coordinates of the subpixel; the transmission paths of light from individual subpixels to the photosensor on the side end face of the display panel are different. The light that leaks from the side end face of the display panel is generated by light emission of a pixel but it has attenuated as it travels through the TFT substrate or the encapsulation substrate. The attenuation amount in the travel has dependency on the wavelength and further, it varies with traveling distance. Accordingly, preparing a conversion coefficient for the coordinates of each subpixel enables appropriate conversion. Although the coordinates of three subpixels constituting one display pixel are the same in the example of FIG. 7, they can be different. The coefficients for the different subpixels of the same display pixel can take the same value.

The intensity of light of an OLED element that goes out to the front of the display region can be estimated by multiplying the intensity of light of the OLED element leaking at the photosensor 31 acquired by the lock-in amplifier 33 by the coefficient associated with the OLED element (subpixel) in the light intensity conversion information 43. Although FIG. 7 provides conversion coefficients for individual subpixels in a table format, a function formula representing the relation between coordinates of a subpixel and a coefficient can be used.

The measured light intensity data 44, the initial light intensity data 45, and the display compensation information 46 can include values on individual subpixels in the same format as the light intensity conversion information 43. For example, the measured light intensity data 44 includes the intensities of light that is emitted from individual subpixels and goes out to the front of the display region, which are estimated from detection signals of the photosensor 31.

The main control circuit 21 acquires a measured intensity of leaking light of a subpixel (OLED element) from the lock-in amplifier 33. The main control circuit 21 refer to the light intensity temperature compensation information 41 and the photosensor sensitivity temperature compensation information 42 for the temperature provided from the temperature measuring circuit 39 and adjusts the measured intensity of leaking light based on the referred results. The main control circuit 21 acquires a coefficient for the subpixel from the light intensity conversion information 43 and converts the temperature-compensated measured intensity of leaking light at the photosensor into an estimated intensity of light going out to the front of the display region. This estimated intensity of light going out to the front of the display region is stored to the measured light intensity data 44.

The initial light intensity data 45 stores frontal light intensities of individual subpixels actually measured before shipment of the OLED display device 10, for example. Specifically, the values stored in the initial light intensity data 45 are frontal light intensities of individual subpixels actually measured after the OLED elements have got emission characteristics substantially the same as when the OLED display device 10 is about to be practically used through aging treatment for stabilizing their emission characteristics, not immediately after the OLED elements are fabricated as a display panel. The aging treatment is applied after the OLED elements are fabricated as a display panel or such a display panel is assembled into an OLED display device 10. In another example, the initial light intensity data 45 can store the frontal light intensities before the OLED elements deteriorate, for example, at the time of the first deterioration evaluation of the OLED elements.

An example of the display compensation information 46 includes compensation coefficients conforming to the deterioration levels of individual subpixels. The compensation coefficients are provided for individual subpixels at each emission level. The signal adjustment circuit 22 acquires the display compensation information 46 from the main control circuit 21. The signal adjustment circuit 22 generates deterioration-compensated display data from emission levels of individual subpixels and the compensation coefficients specified in the display compensation information 46 and outputs it to the display signal circuit 16. The signal adjustment circuit 22 can adjust an emission level (for example, one of 0 to 255) acquired from the main control circuit 21 in accordance with the display compensation information 46 or adjust the display data calculated from the emission levels in accordance with the display compensation information 46. The display compensation information 46 is information allowing for maintaining the initial γ characteristic of the OLED display device so that the deterioration-compensated display can maintain the white balance.

The display compensation information 46 can include a function formula representing the relation between the degree of deterioration of a subpixel and the compensation coefficient at each emission level. The parameters for deterioration compensation in the display compensation information 46 depend on the design of the OLED display device; they can be compensation coefficients for each subpixel or coefficients in the function formula.

When the display panel has deteriorated all over the display region or in a specific area, the main control circuit 21 calculates display compensation information to diminish or eliminate the degradation of display quality caused by the deterioration. For example, the main control circuit 21 calculates the display compensation information 46 by a predetermined calculation method, based on the comparison result of the measured light intensity data 44 with the initial light intensity data 45. In another example, the main control circuit 21 can calculate the display compensation information 46 based on the light intensity distribution generated from the measured light intensity data 44. For example, the main control circuit 21 determines the display compensation information 46 so that the variation in light intensity among subpixels in the measured light intensity data 44 will be small. Reducing the variation in light intensity can include adjustment like the following: in a case where subpixels in a first region and subpixels in a second region adjoining the first region are assigned the same uniform display data but they light at different average intensities and exhibit a significant difference in light intensity along the boundary, the main control circuit 21 adjusts the light intensities to make the boundary less perceivable, instead of adjusting the light intensities of the whole regions.

A part of the information stored in the storage circuit 23 shown in FIG. 4 can be excluded. For example, the light intensity temperature compensation information 41, the photosensor sensitivity temperature compensation information 42, and the light intensity conversion information 43 can be excluded. The light intensity temperature compensation information 41 and the photosensor sensitivity temperature compensation information 42 can be unified and the resulting compensation information can provide a coefficient for adjusting the light intensity and the sensor sensitivity together for each temperature.

In the case of no light intensity conversion information 43, the measured light intensity data 44 and the initial light intensity data 45 include the intensities of leaking light at the photosensor 31. In a configuration where the main control circuit 21 determines display compensation information 46 to attain uniform in-plane brightness with reference to the measured light intensity data 44, the initial light intensity data 45 can be excluded. The measured light intensity data 44 can be erased after the display compensation information 46 is generated (updated).

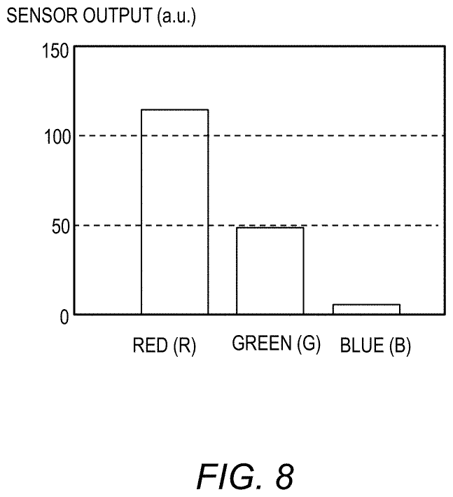

FIG. 8 illustrates examples of outputs of the photosensor 31. The graph of FIG. 8 provides the sensor outputs when the subpixels in the entire display panel are lit color by color at their maximum emission level (the emission level of 255). Specifically, FIG. 8 provides the results measured in an experimental dark room or under the condition where there is no influence of external light. They are raw outputs of the photosensor in response to displaying red (R), green (G), and blue (B); a lock-in amplifier was not used.

The red, green, and blue subpixels were separately lit at the emission level of 255; if all subpixels had been lit simultaneously, the display region 12 would have displayed white. Although it is natural that the sensor outputs have differences among red, green, and blue as indicated in FIG. 8; they are obviously not in the proportion to satisfy the white balance. This indicates that the attenuation rates in the light transmission paths from a subpixel to the photosensor 31 within the OLED display device 10 are different depending on the color or the wavelength. The wavelength dependency of the photosensor 31 may also be a cause. Accordingly, preparing control information for individual colors as illustrated in FIG. 7 enables more appropriate deterioration compensation.

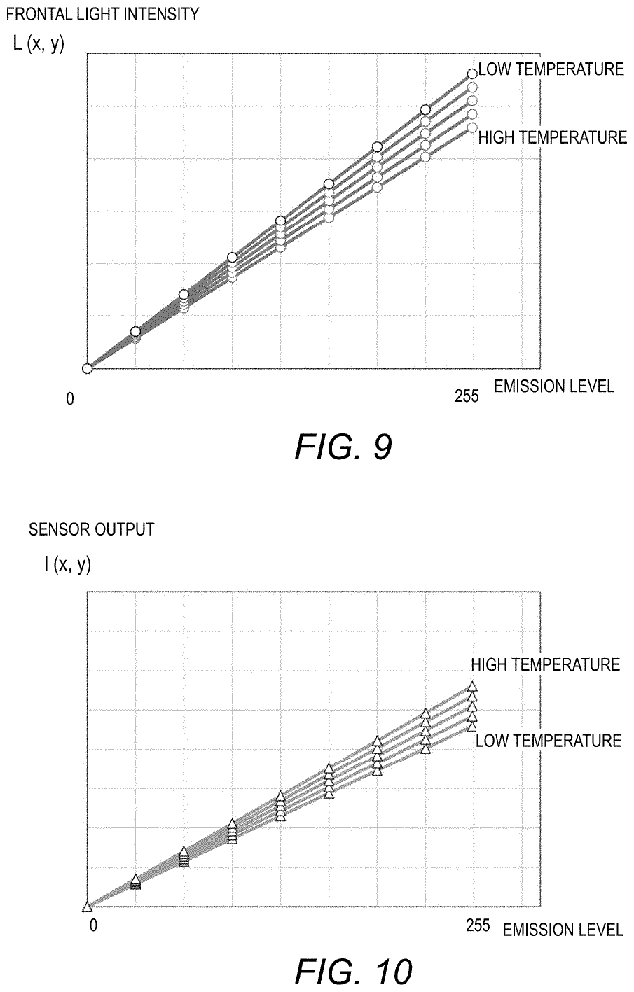

FIG. 9 schematically illustrates relations between the intensity of light going out to the front of the display region when an OLED element of a subpixel at the coordinates (x, y) emits light under different temperatures and the emission level calculated from image data. Although the examples in FIG. 9 are expressed so that the emission level and the frontal light intensity have a linear relation, the actual relation depends on not only the characteristics of the OLED element but also the γ characteristic configured in the control circuits and display signal circuit.

As noted from FIG. 9, the light intensity reduces with increase of temperature at all emission levels. The light intensity temperature compensation information 41 is configured based on such an emission characteristic of OLED elements. The light intensity temperature compensation information 41 enables a measured value to be converted to a value at a standard temperature, eliminating the temperature dependency of an OLED element to achieve more accurate deterioration evaluation of the OLED element.

FIG. 10 schematically illustrates relations between the output of the photosensor at different temperatures in response to light emission of an OLED element of a subpixel at the coordinates (x, y) and the emission level calculated from image data. In this experiment, the light intensity of the OLED element does not vary if the emission level is the same and it does not depend on the temperature of the photosensor. Although the examples in FIG. 10 are expressed so that the emission level and the output of the photosensor have a linear relation, the actual relation depends on not only the characteristics of the OLED element but also the γ characteristic configured in the control circuits and display signal circuit.

As noted from FIG. 10, the output of the sensor increases with increase of temperature at all emission levels. The photosensor sensitivity temperature compensation information 42 is configured based on this characteristic of the photosensor. The photosensor sensitivity temperature compensation information 42 enables a measured value to be converted to a value at a standard temperature, eliminating the temperature dependency of the photosensor to achieve more accurate measurement of the light intensity of an OLED element.

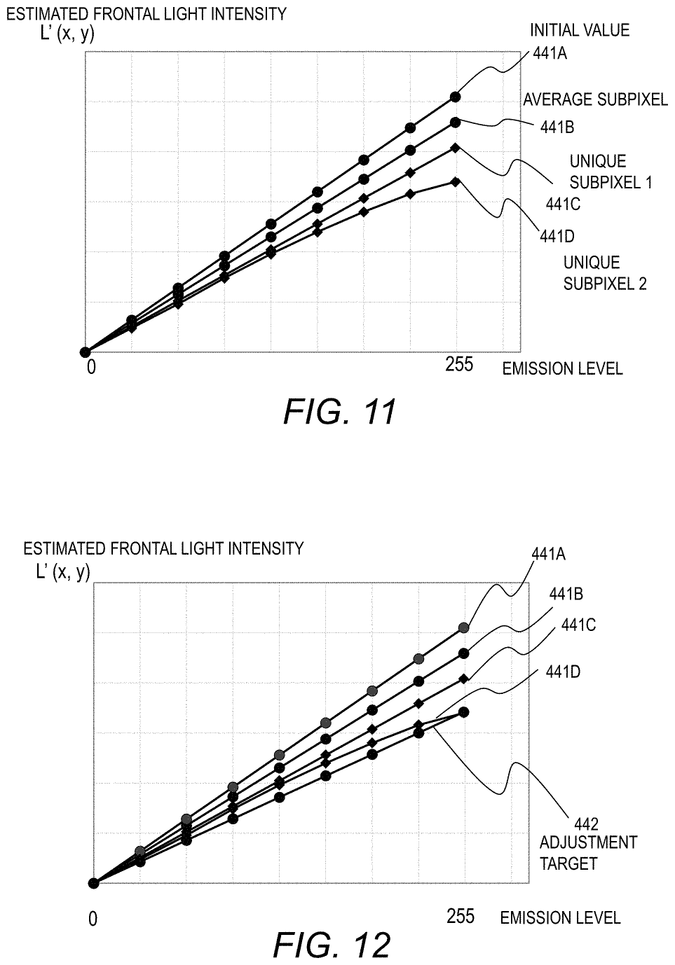

FIG. 11 schematically illustrates an example of comparison results of estimated frontal light intensities of OLED elements of a plurality of subpixels at different coordinates (x, y) acquired under an actual use environment after the OLED display device 10 has aged. As described above, the main control circuit 21 estimates the frontal light intensity from the measured intensity of leaking light of an OLED element that is extracted by the lock-in amplifier 33 from the output of the photosensor 31 with reference to the light intensity temperature compensation information 41, the photosensor sensitivity temperature compensation information 42, and the light intensity conversion information 43. In the graph of FIG. 11, the horizontal axis represents the emission level and the vertical axis represents the estimated frontal light intensity.

In FIG. 11, the line 441A represents the estimated initial frontal light intensity. The line 441B represents the estimated frontal light intensity of an average OLED element that has deteriorated with duration of use of the OLED display device 10. The estimated frontal light intensity is lowered at every emission level because of deterioration of the OLED element. The lines 441C and 441D represent estimated frontal light intensity of OLED elements that have deteriorated more than the average OLED element. For example, the line 441D represents the estimated frontal light intensity of a subpixel that has deteriorated most among all subpixels.

In the case where a plurality of OLED elements showing the characteristic represented by the line 441C are gathered in a region composed of averagely deteriorated OLED elements showing the characteristic represented by the line 441B, the intensities of light emitted by the OLED elements have a difference in the vertical direction between the line 441B and 441C in FIG. 11, even if the whole display region is controlled to display at the same emission level. This difference corresponds to the difference in the degree of deterioration progressed with duration of use of the OLED display device; it is caused by the difference in the degree of load that depends on the emission levels and the display time during the duration of use. As a result, images displayed without compensation for the deterioration exhibit the difference in light intensity corresponding to the image displayed for a long time, which is perceived of as a so-called burn-in.

The main control circuit 21 determines a desired characteristic for each subpixel based on the estimated frontal light intensity of the whole display region 12 and adjusts the emission control for each subpixel so that the subpixel will show a characteristic close to the desired one. The main control circuit 21 can shift the emission levels of image data. In another example, the main control circuit 21 can alter the display data specifying the driving current for each OLED element to change the light intensity.

In the case of adjustment by emission level, the main control circuit 21 generates emission levels for driving by altering the emission levels of image data. In general, driving at a level higher than the maximum level is not available. The adjustment by deterioration compensation darkens the display region 12 overall. FIG. 12 includes an example of a desired characteristic 442, in addition to the estimated frontal light intensities 441A to 441D. The desired characteristic 442 is determined to conform to the emission characteristic 441D of the most deteriorated subpixel.

In the example of FIG. 12, the estimated frontal light intensities in accordance with the desired characteristic 442 are equal to or lower than the estimated frontal light intensities of the most deteriorated characteristic 441D at all emission levels. The desired characteristic 442 shows a proportional relation between the emission level and the estimated frontal light intensity so as to conform to the characteristic of undeteriorated OLED elements. Like this example, adjustment to keep the proportional relation between frontal light intensities and emission levels is available even though the degrees of deterioration are different among OLED elements assigned different emission levels.

The description with reference to FIG. 12 is based on the schematic graph where the characteristic of an undeteriorated OLED element has a linear relation to the RGB intensity levels, namely a relation of γ=1. Accordingly, the characteristic after deterioration compensation is configured to have the relation of γ=1 so that the displayed image will not be affected before and after the OLED element deteriorates. In actual situations, however, the deterioration characteristics of subpixels are usually different among the colors of R, G, and B. If deterioration compensation is applied individually to the different colors of subpixels, the white balance will be broken. Accordingly, the main control circuit 21 generates display compensation information to attain adjustment that maintains the γ characteristic to keep the white balance, although details of the method of generating such information are not provided here.

In the above-described configuration of adjustment where the deterioration compensation leads to lowering the light intensities of subpixels, the main control circuit 21 can avoid or reduce darkening the whole display region using another function for adjusting the overall brightness of the display region 12. Although the foregoing description has provided a method of deterioration compensation to uniformize the whole display region, adjustment to mitigate the influence of the significant difference in emission characteristic along the boundary of a burn-in can be employed to reduce the visibility of the burn-in, instead of adjustment to uniformize the display region 12. To obtain adjustment information based on deterioration information, a predefined mathematical formula or a specific algorithm can be used. Moreover, an artificial intelligence (AI) can be used to reduce the visibility of the boundary of a burn-in.

### Measurement Before Shipment

Hereinafter, a method of generating control data to be preset to the OLED display device 10 is described. In the example described with reference to FIG. 4, the light intensity conversion information 43 and the initial light intensity data 45 are preset to the OLED display device 10 together with the light intensity temperature compensation information 41 and the photosensor sensitivity temperature compensation information 42.

During the fabrication of an OLED display device 10, the emission characteristic of the display panel 11 and the sensitivity characteristic of the photosensor 31 with respect to the temperature are measured and temperature compensation information 41 and 42, light intensity conversion information 43, and initial light intensity data 45 are generated. If those characteristics are stable among OLED display devices, representative values common to a plurality of OLED display devices can be adopted.

The procedure in fabricating an OLED display device 10 is described in more details with reference to FIG. 21. The OLED display device 10 has a configuration of FIG. 1; its display region 12 is exposed to the external. Further, the OLED display device 10 has an interface (not shown in the drawings) for the main control circuit 21 (not shown in FIG. 21) to communicate signals and data for controlling its own operation with the external.

In the factory, the OLED display device 10 is placed in a measurement environment 200 and connected to a measurement apparatus 201 through its interface to communicate control signals and data with the measurement apparatus 201. The measurement apparatus 201 is connected to an external photosensor 210. The measurement apparatus 201 includes a lock-in amplifier to perform lock-in measurement synchronously with blinks of a pixel. The external photosensor 210 is disposed in front of the display region 12 of the OLED display device 10. The external photosensor 210 senses the light emitted from an OLED element, measures its intensity, and forwards the measurement result to the measurement apparatus 201.

The external photosensor 210 has a not-shown mechanism to move the external photosensor 210 to the front of the OLED element that emits light to be measured. The measurement environment 200 includes a not-shown temperature controller and a simulated external light source 203. The measurement environment 200 may include a light shielding device 205 to attain a dark-room environment. The temperature controller can control the temperature of the measurement environment 200, and the OLED display device 10 and the external photosensor 210 in the measurement environment 200. The simulated external light source 203 illuminates the display region 12 to imitate the external light in the actual use environment. The influence of the external light will be described later.

The measurement apparatus 201 measures the frontal light intensity of each subpixel in the display region 12 with the external photosensor 210 and simultaneously, measures the intensity of leaking light at the location of the photosensor 31. The leaking light can be measured with the photosensor 31 (not shown in FIG. 21) already attached to the display panel 11. This light intensity measurement can be performed in the same way as the measurement for deterioration evaluation in the actual use environment. That is to say, the intensity of pulse-modulated light is measured.

The measurement apparatus 201 controls the display panel 11 to light subpixels one by one. Further, the measurement apparatus 201 moves the external photosensor 210 to above the selected subpixel and measures the frontal light intensity. The measurement apparatus 201 controls the display panel 11 to supply pulse-modulated power supply potential from the pulsed power supply to the common electrode of the display panel 11. The pulsed power can also be generated by switching on and off the DC power supply.

The measurement apparatus 201 performs lock-in measurement with a modulating signal using the external photosensor 210 disposed in front of the display region 12 and the photosensor 31 attached on the side end face of the display panel 11 and stores the relation between the frontal light intensity and the intensity of leaking light received by the photosensor 31 as light intensity conversion information 43. As to the measurement using the photosensor 31 mounted on the OLED display device 10, the value acquired by the OLED display device 10 can be forwarded to the measurement apparatus 201 via the interface. Regarding a region where deterioration will not progress very differently, measurement can be performed on only some of the subpixels therein and the data on their nearby subpixels can be determined by an interpolation function.

The above-described measurement of light intensities is performed at a plurality of different emission levels. The measurement apparatus 201 determines the relation between the intensity of frontal light and the intensity of leaking light at each emission level. The measurement can be performed on only some of the emission levels and the values at the other levels can be determined by an interpolation function.

The above-described measurement is performed under the condition where the measurement environment 200 is controlled by the aforementioned temperature controller at the standard temperature. The measurement apparatus 201 further measures the frontal light intensity of each subpixel and the sensor output at different temperatures. Then, the relation between the sensitivity of the sensor and the temperature and the relation between the light intensity of an OLED element and the temperature can be measured together. Temperatures in a range expected in the actual use environment are selected for this measurement.

Temperature compensation in accordance with one kind of compensation information is applied to the sensor sensitivity and the light intensity of an OLED element together. The temperature characteristic of the photosensor and the temperature characteristic of OLED elements can be measured separately to prepare temperature compensation information for each of them as illustrated in FIG. 4. If the characteristic of the photosensor and the characteristic of OLED elements are sufficiently stable, representative values common to a plurality of OLED display devices can be adopted without acquiring compensation information from individual OLED display devices.

The above-described measurement of light intensities of subpixels provides the initial light intensity data 45. The measurement in the factory can simultaneously light a plurality of neighboring subpixels constituting a subpixel group and measure the sum of the light intensities of the subpixels. Since a burn-in or a spot that shows different emission characteristics is not expected to be present before shipment, the light intensity per subpixel can be calculated from the measured value.

This configuration shortens the time to measure the light of the whole display region. When a large number of subpixels are lit and measured together, simple calculation could yield a large error, compared to the characteristic acquired when one subpixel is lit and measured. Accordingly, acquiring in advance a value calculated from a plurality of simultaneously lit subpixels and values actually measured individually helps to find the tendency of identically designed OLED display devices and to know the limitations of the measurement of simultaneously emitted light.

### Deterioration Evaluation and Deterioration Compensation

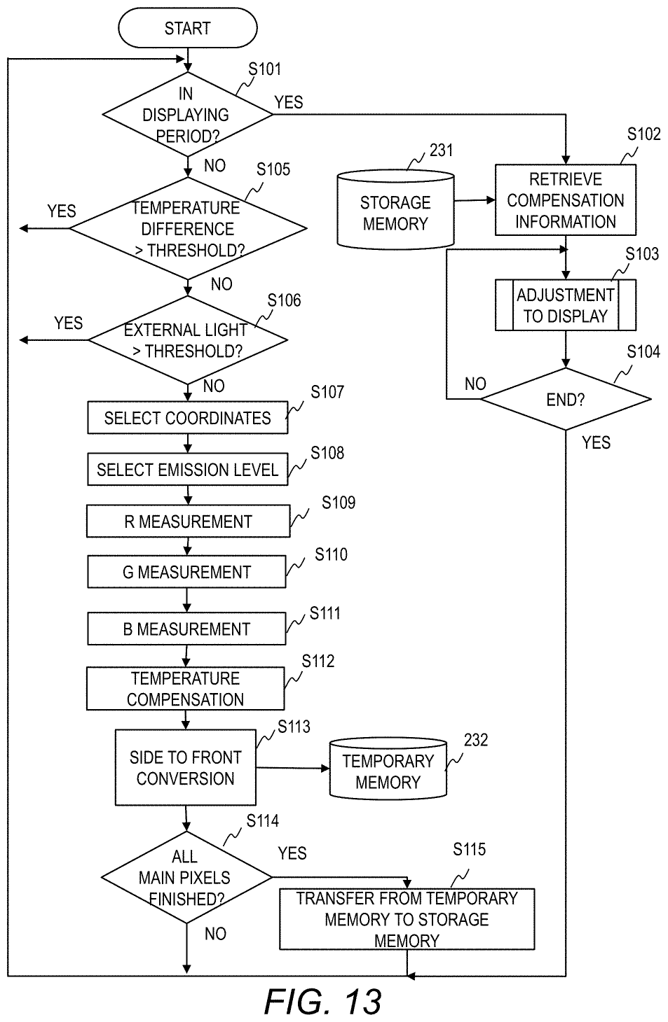

An example of deterioration evaluation of OLED elements under the actual use environment and their deterioration compensation is described. FIG. 13 is a flowchart for an OLED display device 10 to evaluate deterioration of OLED elements in its display region 12 and to adjust the display. As described above, the OLED display device 10 measures the intensity of light leaking from a side end face of the display panel 11 caused by emission of one or more OLED elements (subpixels) with the photosensor 31 attached on the side end face of the display panel 11.

After activation of the OLED display device 10, the main control circuit 21 determines whether the OLED display device 10 is in a displaying period (S101). For example, if input of image data from the external has been stopped over a predetermined time, the main control circuit 21 can determine that the OLED display device is in a non-displaying period. As other examples, the main control circuit 21 can determine that the OLED display device 10 is in a non-displaying period immediately after activation of the OLED display device 10, in receipt of an instruction to power off, or during transition to a sleep mode.

If the OLED display device 10 is in a displaying period (S101: YES), the main control circuit 21 retrieves the display compensation information 46 from a storage memory 231 in the storage circuit 23 (S102). The main control circuit 21 executes adjustment to the display of input image data based on the retrieved display compensation information 46 (S103). All information in FIG. 4 is stored in the storage memory 231.

Specifically, the main control circuit 21 sets the compensation information to the adjustment circuit 22 and the adjustment circuit 22 generates adjusted display data from the emission levels of individual subpixels specified in the image data input from the external. The adjustment to the display is performed (S104: NO and S103) until input of image data ends (S104: YES).

If the determination at Step S101 is that the OLED display device 10 is not in a displaying period (S101: NO), the main control circuit 21 compares the current temperature with a predetermined threshold (S105). If the difference of the current temperature from the standard temperature at the time of acquisition of the initial data is larger than the threshold (S105: YES), the main control circuit 21 returns to Step S101. Measurement at a temperature significantly different from the standard temperature yields a large variation of data by temperature compensation, causing an error. This avoidance of deterioration evaluation in the temperature range that cannot assure an accurate result enables the compensation information to be updated more accurately. Only either the upper limit or the lower limit of the temperature range to pursue deterioration evaluation can be provided. Further, elapse of a specific time since the previous measurement can be included in the conditions to start deterioration evaluation.

If the difference between the current temperature and the standard temperature is equal to or smaller than the threshold (S105: NO), the main control circuit 21 compares the intensity of external light with a predetermined threshold (S106). The intensity of external light can be measured with the photosensor 31 or another photosensor. If the intensity of the external light is higher than the threshold (S106: YES), the main control circuit 21 returns to Step S101.

The display device in an embodiment of this specification can efficiently eliminate the influence of noise components caused by the external light by lock-in measurement. However, the influence of external light cannot be perfectly eliminated under the condition where the midsummer sunlight is directly hitting the display region, for example. The external light incident on the display surface enters from the display surface to the inside of the display panel; a part of the light reaches the photosensor on the side end face of the display panel. There is a tremendous difference between the intensity of the light from one OLED element and the intensity of the sunlight incident on the whole display region. Even comparison of the light reaching the photosensor reveals that the intensity of the external light is very high. This avoidance of deterioration evaluation under the intensity of external light that cannot assure an accurate result enables the compensation information to be updated more accurately. The magnitude of the influence of the external light will be described later.

If the environmental conditions for deterioration evaluation are satisfied (S105: NO, S106: NO), the main control circuit 21 successively lights the subpixels to perform deterioration evaluation. The main control circuit 21 can perform the deterioration evaluation on all subpixels or some selected subpixels. Meanwhile, the main control circuit 21 can simultaneously light a plurality of neighboring subpixels to perform the deterioration evaluation on those subpixels.

At the time of deterioration evaluation, however, a burn-in may exist, unlike the time of acquisition of the initial characteristics. If the result of this aggregative measurement on the plurality of subpixels (the sum of the light intensities) shows a decrease larger than a threshold and suggests that a significantly deteriorated subpixel is included in the subpixels, the main control circuit 21 can individually measure the light intensities of the plurality of subpixels. In another example, the main control circuit 21 can perform the individual measurement on each subpixel in a subpixel group from which significant deterioration has been detected in the previous measurement and perform aggregative measurement on the subpixels of the other subpixel groups. This configuration achieves reduction in time for the deterioration evaluation. The following description is provided assuming that the deterioration evaluation is performed on all subpixels one by one.

The main control circuit 21 selects coordinates of a display pixel that has not been selected yet (S107) and further, selects an unselected emission level for the selected display pixel (S108). Thereafter, the main control circuit 21 separately measures the light intensities of the red subpixel, the green subpixel, and the blue subpixel of the selected display pixel (S109, S110, and S111).

The main control circuit 21 lights each subpixel at the selected emission level. At this time, the main control circuit 21 lights the subpixel at the selected emission level without applying deterioration compensation. As described above, the main control circuit 21 pulse-modulates the lighting of the subpixel and performs lock-in measurement with the lock-in amplifier 33.

As described above, the main control circuit 21 writes a display signal specifying the selected emission level to the subpixel and switches the power supply for the common electrode of the OLED element from the DC power supply 25 to the pulsed power supply 35. The pulsed power supply 35 supplies pulse-modulated power supply potential to the common electrode. As a result, the subpixel blinks at a desired frequency. The pulsed power supply 35 can pulse-modulate the emission of an OLED element appropriately at a desired frequency higher than the frame frequency.

There is a possibility that external light may enter the display panel 11 from its display surface and reach the photosensor 31. The blinking frequency is determined to avoid a specific frequency so that the light of the OLED element can be separated from the noise from the external. Avoiding the integral multiples of the expected external noise, such as the utility power frequency, improves the noise immunity and increases the accuracy in measurement.

The main control circuit 21 alters the intensity values of red, green, and blue leaking light of the OLED elements detected by the photosensor 31 and extracted by the lock-in amplifier 33 based on the light intensity temperature compensation information 41 and the photosensor sensitivity temperature compensation information 42 (S112). Further, the main control circuit 21 estimates the intensities of the light going out to the front of the display region 12 from the temperature-compensated light intensities based on the light intensity conversion information 43 (S113). The main control circuit 21 stores the estimated frontal light intensities of the red, green and blue subpixels and display compensation information based on the estimated frontal light intensities of those subpixels to a temporary memory 232 in the storage circuit 23. The simplest display compensation information 46 for attaining predetermined desired characteristics can be generated as described above.

The main control circuit 21 determines whether light intensities of all display pixels have been measured (S114). If some display pixel is remaining (S114: NO), the main control circuit 21 returns to Step S101. If light intensities of all display pixels have been measured (S114: YES), the main control circuit 21 transfers the measured light intensity data 44 and the display compensation information 46 stored in the temporary memory 232 to the storage memory 231 (S115).

The display compensation information 46 can be calculated after light intensities of all subpixels are measured. If measured light intensity data has been acquired from all subpixels, a desired characteristic can be determined based on the measured data. To perform not simple but complex display compensation, such as lowering the visibility of the outline of a burn-in, the display compensation information is to be generated by a predetermined method after the light intensities of all subpixels are measured. To calculate the display compensation information based on deterioration information, a predefined mathematical formula or a specific algorithm can be used. Moreover, an artificial intelligence (AI) can be used to reduce the visibility of the boundary of a burn-in.

When the display device 10 enters a displaying period before deterioration evaluation (measurement of light intensities) of all subpixels is finished (S101: YES), the main control circuit 21 suspends the deterioration evaluation and performs normal displaying operation (S102 and S103).

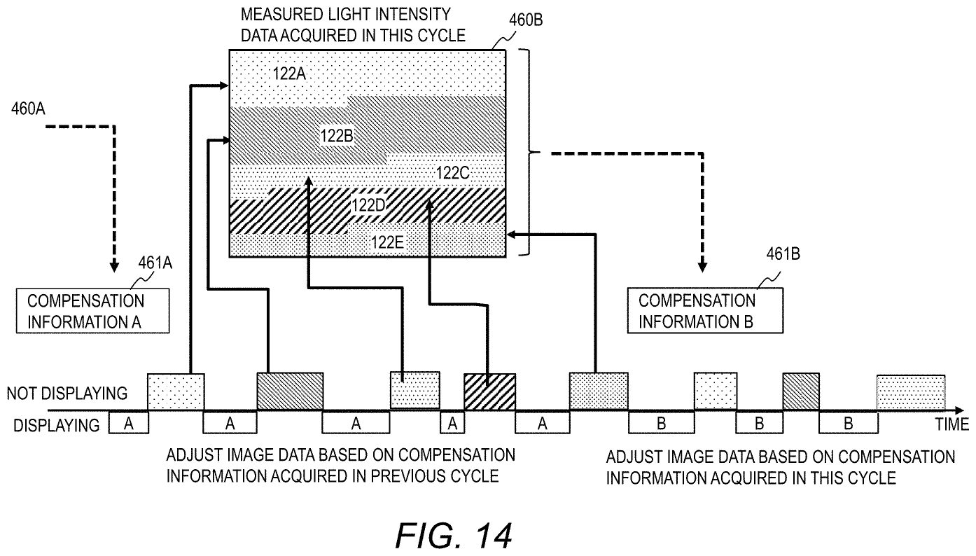

FIG. 14 is a conceptual diagram of intermittently acquiring display compensation information 46 for the entire display region 12. In this section, the period taken to acquire display compensation information for the entire display region 12 is referred to as cycle. Before completion of the current cycle of deterioration evaluation of the entire display region 12, the main control circuit 21 refers to the display compensation information 461A generated based on the measured light intensity data 460A acquired in the previous cycle to display image data. As described above, the main control circuit 21 performs deterioration evaluation of OLED elements in the partial regions 122A to 122E of the display region 12 successively in the intermittent periods (standby periods) other than displaying periods. The measured light intensity data of each partial region is stored to the temporary memory 232.

When measurement on all OLED elements in the display region 12 is finished, measured light intensity data 460B is completed. The main control circuit 21 generates display compensation information 461B for the entire display region 12 in this cycle based on this data and stores the display compensation information 461B to the storage memory 231. Thereafter, the display compensation information 461B is referred to in displaying image data.

The condition of the entire display region can be determined based on the light intensities measured in a plurality of separate periods. The light intensities of subpixels in the entire display region do not have to be measured in one measurement period. In the second and the subsequent measurement on the remaining subpixels in the display region 12, the main control circuit 21 conducts measurement on some of the already measured display pixels again and compares the results with the previous measured data. At the time of the second and subsequent measurement, the OLED display device could have been used too long to ignore the progress of deterioration or the temperature could be significantly different from the one at the previous measurement. If there is a big difference in temperature between the previous measurement and the present measurement, the possibility of error increases, even though temperature compensation is applied.

The measurement results acquired from a display pixel for a plurality of times can be adjusted to eliminate the discontinuity between the measurement results in different measurement periods. Such adjustment can reduce the error between data acquired separately. Meanwhile, if the difference between the values measured from the same display pixel is larger than a threshold, the main control circuit 21 can discard the previously measured data in the temporary memory and retry the present cycle of measurement.

This configuration eliminates the influence of unexpected measurement error and increases the accuracy in measurement. In another example, one cycle of measurement can be repeated for a plurality of times to determine the measurement results of one cycle. A measurement result on the same pixel at the same emission level in one cycle can be determined through a process of eliminating abnormal values from the results of a plurality times of measurement and averaging the results. Such a statistical analysis on results of a plurality of times of measurement increases the accuracy in measurement. The increase in time to be taken for the measurement can be determined in consideration of the balance between the required accuracy for the measurement and the operating conditions of the display device.

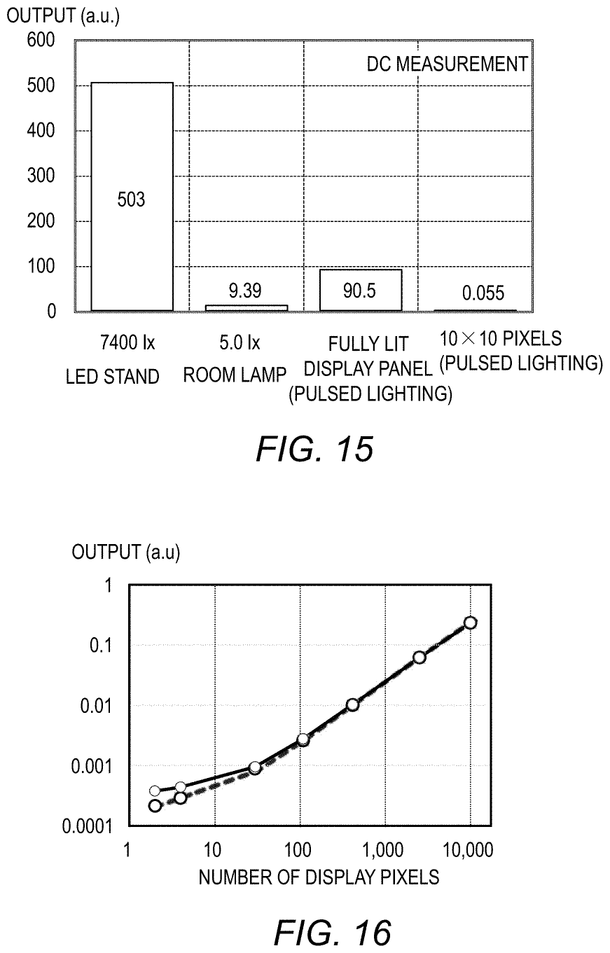

FIG. 15 provides examples of outputs of the photosensor 31 attached on a side end face of the display panel 11 in response to different kinds of light. FIG. 15 presents comparison of the intensity of light emitted from OLED elements of the display panel 11 and the intensity of external light. In the case of the external light, the measured is the intensity of light that enters the display panel 11 from the display surface, travels through inside the display panel 11, and reaches the side end face of the display panel 11. In the case of OLED elements, the measured is the intensity of leaking light that is emitted from the OLED elements, travels through inside the display panel 11, and reaches the side end face of the display panel 11.

In the graph of FIG. 15, the vertical axis represents the result of DC measurement on the output of the photosensor transmitted through a pre-amplifier. FIG. 15 provides the results of DC measurement on the light under an LED stand (7400 lx), the light under a dark room lamp (5.0 lx), the light of fully lit display panel in a dark room (pulsed lighting), and the light of 10×10 display pixels in a dark room (pulsed lighting). The frequency of the pulsed lighting was 520 Hz. The pulsed lighting of the display panel provides light corresponding to the light from OLED elements to be measured in an embodiment of this specification, from which the influence of external light has been eliminated. The illuminances of the LED stand and the dark room lamp as the sources of external light are measured directly above the display region of the OLED display device.

Among the measurement results in FIG. 15, the sensor output about the LED stand is the highest and the sensor output of the lighting 10×10 display pixels is the lowest. The external light has an intensity of approximately 9000 times as high as the light of the OLED elements. Even the dark room lamp has an intensity of approximately 170 times as high as the light of the OLED elements. Accordingly, it is obvious that the light from the OLED elements is buried in the external light and cannot be detected if it is measured as it is (without lock-in measurement). As indicated in the measurement results in FIG. 15, the influence of the external light on the sensor output is extremely large.

FIG. 16 provides examples of the results of lock-in measurement of the light leaking from the side end face of the display panel when different numbers of display pixels are lit. In the graph of FIG. 16, the horizontal axis represents the number of lit display pixels and the vertical axis represents the result of lock-in measurement. FIG. 16 shows the results acquired in a dark room as a broken line and the results acquired under the condition where the aforementioned LED stand is lit as a solid line. As indicated in FIG. 16, the lock-in measurement under the condition where the LED stand is lit provides the substantially the same results as the measurement in the dark room. If several tens or more display pixel are lit, the influence of the LED stand is eliminated.

FIG. 16 indicates that the above-described setup can perform measurement under average indoor lighting without any problem, even if the light to be measured is from one display pixel. The lock-in measurement can significantly reduce the influence of the noise of external light to measure the light intensity of an OLED element with high accuracy.

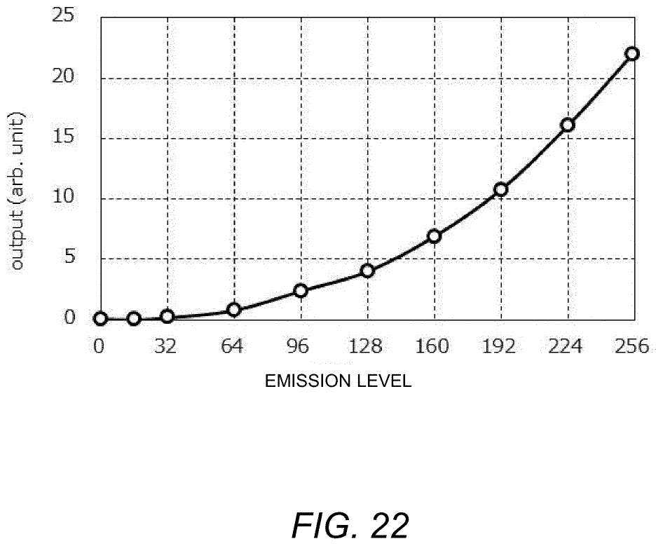

FIG. 22 provides examples of measurement results when the RGB intensity levels of 10×10 display pixels at the center of the display panel are changed stepwise from 0 to 255. FIG. 22 provides the results of lock-in measurement on the leaking light at the photosensor attached on the side end face of the display panel. The measurement environment corresponds to the condition under the aforementioned dark room light (5.0 lx). Lock-in measurement enables measurement of the emission-level-dependent emission characteristic of OLED elements in a tiny area in the actual use environment without hampering the appearance of the OLED display device and further, deterioration evaluation of the display characteristics becomes available with the frontal light intensities estimated from the results of the lock-in measurement.

### Other Embodiments

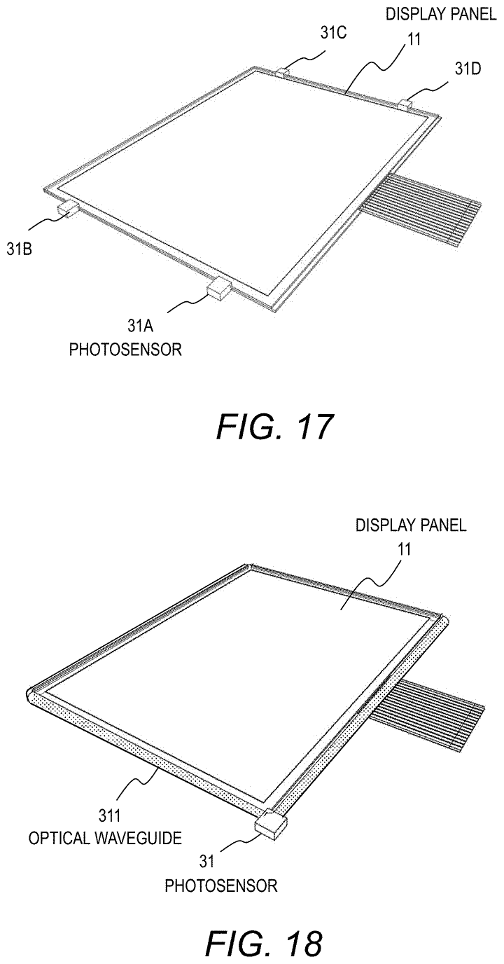

Another example of photosensor disposition is described. Using a plurality of photosensors disposed at different positions enables more appropriate measurement of light intensities of OLED elements in deterioration evaluation. FIG. 17 illustrates an example of a plurality of photosensors attached on side end faces of the display panel 11. Two photosensors 31A and 31B are attached on one side end face of the display panel 11 and the other two photosensors 31C and 31D are attached on the opposite side end face.

Detecting leaking light of an OLED element with the plurality of photosensors 31A to 31D can comprehensively magnify the light signal. The main control circuit 21 can calculate the light intensity of the OLED element based on the detection signals of the photosensors, the locations of the photosensors, and the location of the lit subpixel (OLED element). This configuration enables more appropriate measurement of light intensity of an OLED element.

Another approach to increase the intensity of the detection signal representing the light intensity of an OLED element is to use an optical waveguide. The optical waveguide guides the light leaking from one or all of the end faces of the display panel 11 to the photosensor. FIG. 18 illustrates an example of an optical waveguide 311 for guiding the light leaking from the end faces of the display panel 11 to the photosensor 31.

An example of the optical waveguide 311 is an optical fiber. For example, an optical fiber is provided to surround the outer end of the display panel 11. The core of the optical fiber is exposed to the end faces of the display panel and the other part of the optical fiber is covered with a reflective layer. The optical fiber receives light leaking from the end faces of the display panel 11 and guides the light to the photosensor 31.

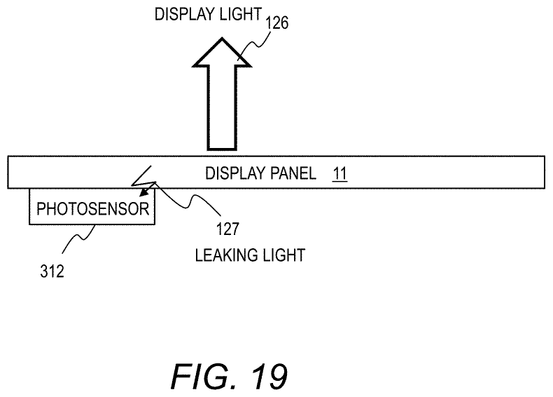

The photosensor for deterioration evaluation of OLED elements can be a photosensor provided for a different purpose. For example, some smartphones have an under-display camera configuration as illustrated in FIG. 19 and includes an internal camera disposed behind the display panel 11. Leaking light can be measured with the photosensor 312 of this camera, so that deterioration evaluation of OLED element can be performed without an additional photosensor.

As still another example, there are known devices such as a smartphone having a function of performing fingerprint authentication within a screen. In the configuration employing optical fingerprint detection, a fingerprint sensor module including a photosensor is provided behind the screen. In such a configuration, leaking light of an OLED element can be measured with the photosensor and no additional component is necessary.

Not being limited to the foregoing examples, as far as an OLED display device or an apparatus including an OLED display device has a light detection function and its photosensor receives leaking light of the OLED display device, the photosensor can be used for deterioration evaluation. If leaking light adversely affects the original light detection function, a light shielding function against leaking light that can be disabled when the photosensor is used for deterioration evaluation of OLED elements will work. Not being limited to the examples where a photosensor is attached on a narrow area of the display panel 11, a large photosensor or multiple photosensors can be mounted on a larger area or the whole area of the display panel.

Next, another example of emission control for deterioration evaluation of an OLED element is described. As described above, lock-in measurement is effective to eliminate the influence of external light. The configuration example described with reference to FIG. 1 makes an OLED element blink at a predetermined cycle by supplying pulse-modulated power supply potential from a pulsed power supply to the common electrode.

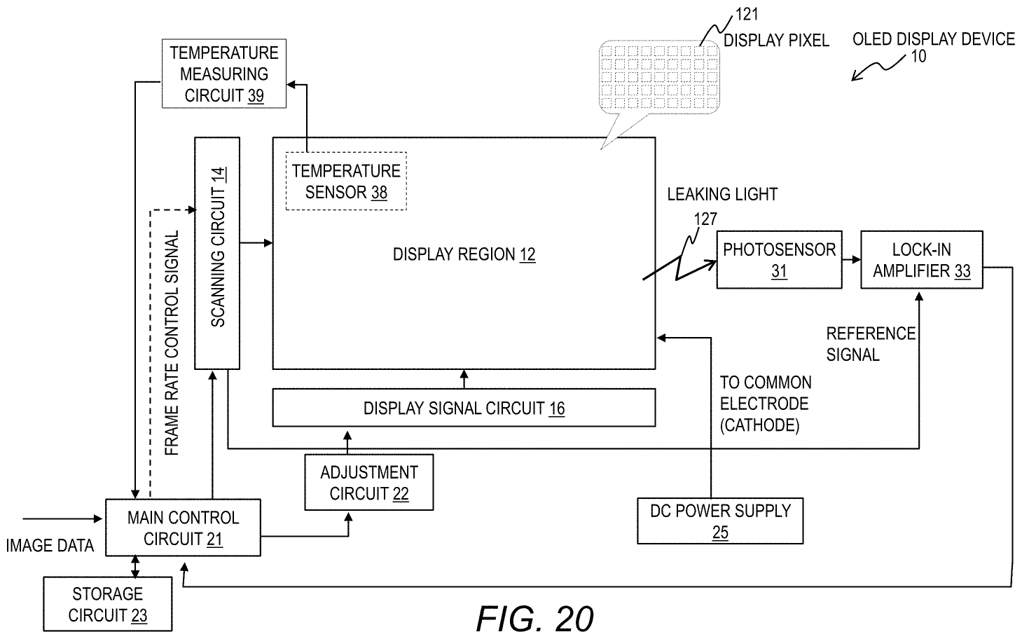

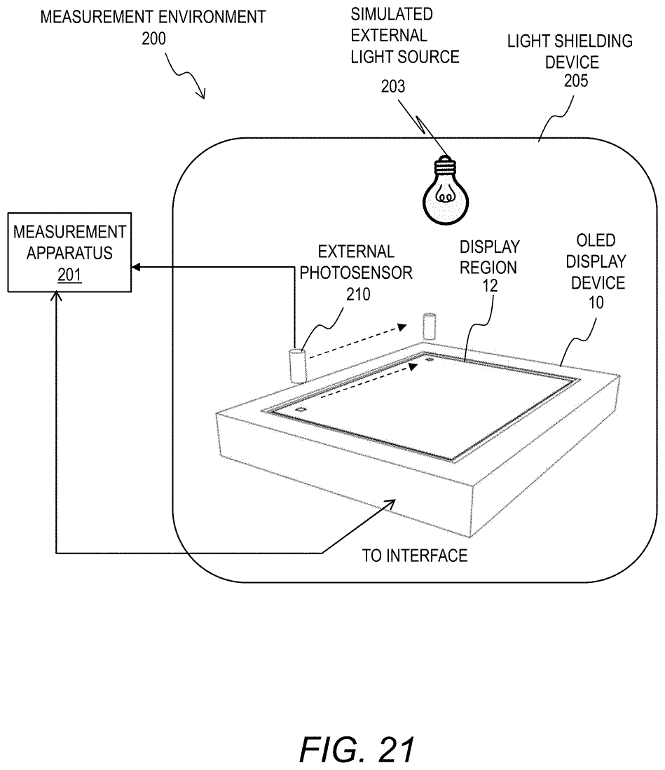

The configuration example described in the following utilizes the frame rewriting operation of the OLED display device to make an OLED element blink. FIG. 20 illustrates a configuration example of an OLED display device that utilizes the frame rewriting operation to make an OLED element blink. The OLED display device 10 makes an OLED element blink in rewriting a frame. This blink can be used as a synchronizing signal.

Differences from the configuration example in FIG. 1 are mainly described. The lock-in amplifier 33 receives a reference signal for lock-in measurement from the scanning circuit 14. The pulsed power supply 35 and the switch 27 are excluded. The remaining is the same as the configuration example in FIG. 1. The main control circuit 21 can make an OLED element blink for the lock-in measurement of the light intensity of the OLED element without additional configuration by employing an effective frame rate for eliminating the influence of the external light. The main control circuit 21 configures the frame rate with the frequency of the clock signal to the scanning circuit 14.

The main control circuit 21 switches lighting and non-lighting of a subpixel (OLED element) with the display signal to be written to the subpixel. For example, a frame period where a subpixel is lit and a frame period where the subpixel is not lit are alternately repeated. The subpixels other than the subpixel to be evaluated are kept off. In this example, a blink requires two frames; the frequency of blinking is ½ of the frame frequency. A simpler way is sending a signal to light at a specific emission level and a signal to turn off alternately at each frame to the subpixel to be evaluated under the same operating conditions as those in the normal operation.

Another configuration example can utilize the non-lighting periods of the display panel for writing a display signal. The display panel is driven by active matrix; it briefly stops lighting every time the data is rewritten at a cycle of the frame frequency. In the active-matrix driving, a selected pixel row applies threshold compensation to the driving transistors therein and writes display signals to the pixels therein in the state where the pixels are not lighting. Although a non-lighting period is short, an OLED element blinks with a component of the frame frequency. Accordingly, detecting the amplitude of the blink synchronously with the frame frequency is available. The period to write a display signal can include a period for threshold compensation for the driving transistor, in addition to the period for writing a display signal to a storage capacitor.

The main control circuit 21 can use a frame frequency different from the one in the normal image displaying operation to make a selected subpixel blink in a non-displaying period. For example, an OLED element blinks for lock-in measurement of the light intensity of the OLED element by frame driving at a frequency higher or lower than the one in the normal displaying operation.

Next, another example of emission control for deterioration evaluation of an OLED element is described. The configuration example described in the following makes an OLED element blink by controlling ON/OFF of the switching transistor for controlling light emission of the OLED element. This configuration reduces the driving delay for making an OLED element blink and further, enables the OLED element to blink at a higher rate than the frame rate. Receiving the blinking light with the photosensor attached on a side end face of the panel and performing synchronous detection with a reference signal corresponding to modulating pulses supplied to a shift register lead to highly accurate measurement of light intensity with the influence of the external light eliminated. Further, the emission control of an OLED element for deterioration evaluation is available using the pixel circuit for displaying images.

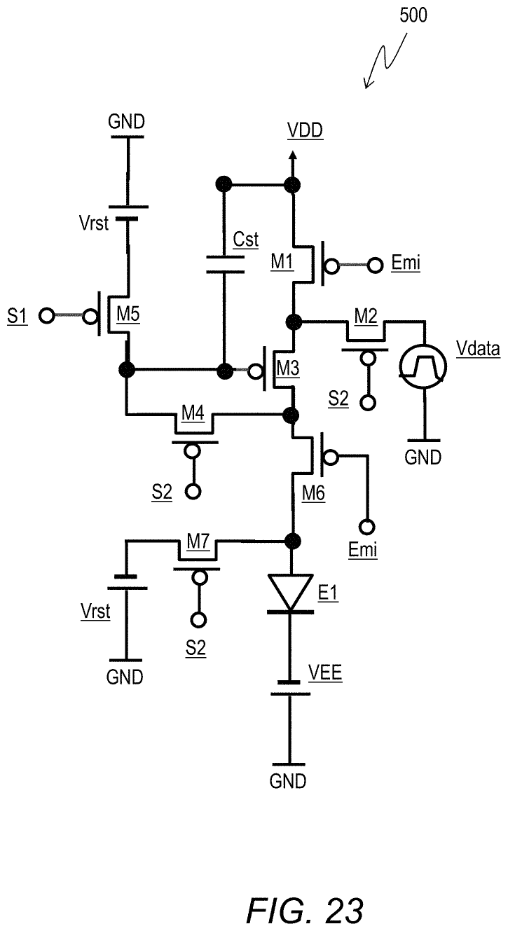

FIG. 23 illustrates a configuration example of a pixel circuit 500 in this example. The pixel circuit 500 adjusts the data signal supplied from the display signal circuit 16 and controls the light emission of the OLED element with the adjusted data signal. A pixel circuit having a configuration different from the pixel circuit illustrated in FIG. 23 can be employed. The pixel circuit does not need to include a circuit for threshold compensation.

The pixel circuit can include a storage capacitor for holding display data for an OLED element, a switching transistor for controlling whether to write display data to the storage capacitor, a driving transistor for controlling the amount of electric current to the OLED element in accordance with the display data in the storage capacitor, and an emission control transistor for controlling whether to supply the current to the OLED element, for example. The pixel circuit can further include other elements such as another capacitor and another switching transistor.

The pixel circuit 500 includes seven transistors (TFTs) M1 to M7 each having a gate terminal, a source terminal, and a drain terminal. The transistors M1 to M7 in this example are p-type MOS-TFTs.

The transistor M3 is a driving transistor for controlling the amount of electric current to an OLED element E1. The driving transistor M3 controls the amount of electric current to be supplied from an anode power supply VDD to the OLED element E1 in accordance with the voltage held by a storage capacitor Cst. The cathode of the OLED element E1 is connected to a cathode power supply VEE. The storage capacitor Cst holds the gate-source voltage (also referred to simply as gate voltage) of the driving transistor M3.

The transistors M1 and M6 control whether to light the OLED element E1. The transistor M1 is connected to the anode power supply VDD through its source terminal to switch ON/OFF the supply of electric current to the driving transistor M3 connected through its drain terminal. The transistor M6 is connected to the drain terminal of the driving transistor M3 through its source terminal to switch ON/OFF the supply of electric current to the OLED element E1 connected through its drain terminal. The transistors M1 and M6 are controlled by the emission control signal Emi input from the scanning circuit 14 to their gate terminals. The transistors M1 and M6 are emission control transistors for controlling ON/OFF of the light emission of the OLED element E1.

The transistor M7 works to supply a reset potential to the anode of the OLED element E1. In response to input of the selection signal S2 from the scanning circuit 14 to the gate terminal, the transistor M7 turns ON to supply the reset potential from the reset power supply Vrst to the anode of the OLED element E1. The other terminal of the reset power supply Vrst is connected to the GND.

The transistor M5 controls whether to supply a reset potential to the gate of the driving transistor M3. In response to input of the selection signal S1 from the scanning circuit 14 to the gate terminal, the transistor M5 turns ON to supply the reset potential from the reset power supply Vrst connected to its drain terminal to the gate of the driving transistor M3. The other terminal of the reset power supply Vrst is connected to the GND. The reset potential to the gate of the driving transistor M3 can be different from the reset potential to the anode of the OLED element E1.

The transistor M2 is a selection transistor for selecting the pixel circuit 500 to be supplied with a data signal. The gate voltage of the transistor M2 is controlled by the selection signal S2 supplied from the scanning circuit 14. When the selection transistor M2 is ON, it supplies the data signal Vdata supplied from the display signal circuit 16 through a data line to the gate of the driving transistor M3 (the storage capacitor Cst).

The selection transistor M2 (the source and the drain thereof) in this example is connected between the data line and the source of the driving transistor M3. Further, the transistor M4 is connected between the drain and the gate of the driving transistor M3.

The transistor M4 works to calibrate the threshold voltage of the driving transistor M3. When the transistor M4 is ON, the driving transistor M3 becomes a diode-connected transistor. The data signal Vdata from the data line is supplied to the storage capacitor Cst through the selection transistor M2 in an ON state and the channels of the driving transistor M3 and the transistor M4.

The storage capacitor Cst stores the gate-source voltage of the driving transistor M3. In the example in FIG. 23, one end of the storage capacitor Cst is connected to the gate of the driving transistor M3 and the other end is connected to a node between the source of the transistor M1 and the anode power supply VDD. The storage capacitor Cst stores the data signal (voltage) adjusted depending on the threshold voltage Vth of the driving transistor M3.

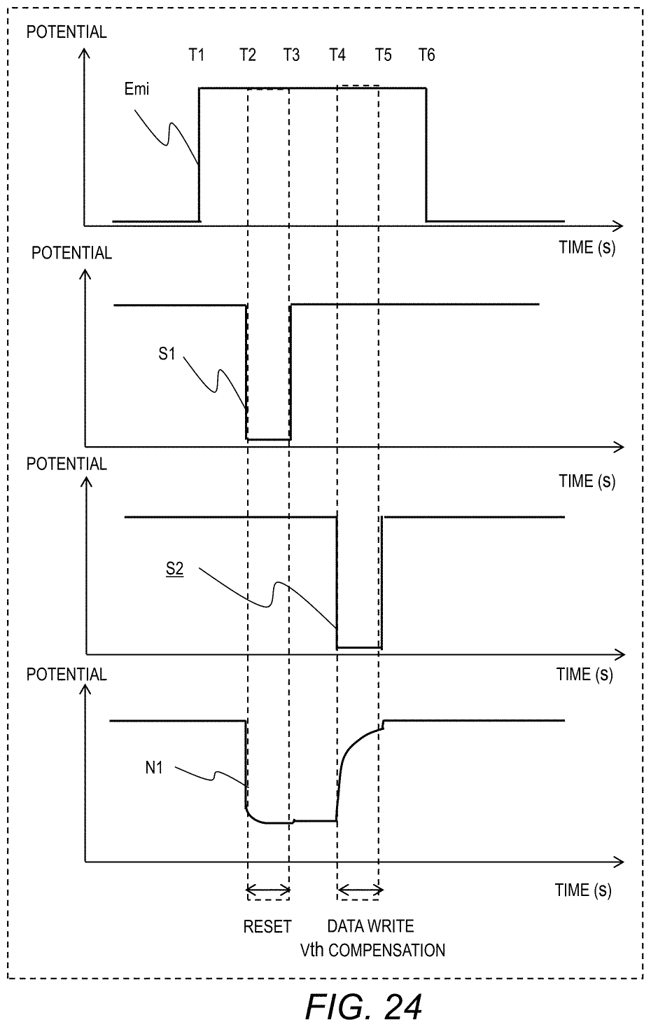

FIG. 24 is a timing chart of the signals for controlling the pixel circuit 500 in FIG. 23 in one frame period under normal image displaying operation. The timing chart of FIG. 24 is to select the N-th row and write a data signal Vdata to the pixel circuit 500. Specifically, FIG. 24 illustrates variations of the emission control signal Emi, the selection signal S1, the selection signal S2, and the gate potential N1 of the driving transistor M3 in one frame. Since the circuit in FIG. 23 is configured with p-type MOS-TFTs, each transistor is ON when its gate potential is Low and OFF when its gate potential is High.

The emission control signal Emi changes from Low to High at a time T1 in FIG. 24. The transistors M1 and M6 are turned OFF in accordance with this control signal. At this time T1, the selection signals S1 and S2 are High. The transistors M2, M4, M5, and M7 are OFF in accordance with these control signals. These states of the transistors are maintained until a time T2 later than the time T1. The gate potential N1 is at the signal potential of the previous frame.

The selection signal S1 changes from High to Low at the time T2. At this time T2, the emission control signal Emi and the selection signal S2 are High. The transistor M5 is turned ON in accordance with the change of the selection signal S1. The transistors M1, M2, M4, M6, and M7 are OFF. The gate potential N1 changes to the potential of the reset power supply Vrst in response to the transistor M5 becoming ON. The reset potential is supplied to the gate of the driving transistor M3 from the time T2 to a time T3.

The selection signal S1 changes from Low to High at the time T3. At this time T3, the emission control signal Emi and the selection signal S2 are High. The transistor M5 is turned OFF in accordance with the change of the selection signal S1. The transistors M1, M2, and M4 to M7 are OFF from the time T3 to a time T4.

The selection signal S2 changes from High to Low at the time T4. At this time T4, the emission control signal Emi and the selection signal S1 are High. The transistors M2, M4, and M7 are turned ON in accordance with the change of the selection signal S2. The transistors M1, M5, and M6 are OFF.

The reset potential of the reset power supply Vrst is supplied to the anode of the OLED element E1 by the transistor M7 becoming ON. Since the transistor M4 is ON, the driving transistor M3 is diode-connected. Since the transistor M2 is ON, the data signal Vdata from the data line is written to the storage capacitor Cst through the transistors M2, M3, and M4.

The voltage to be written to the storage capacitor Cst is a voltage obtained by adjusting the data signal Vdata so as to calibrate the threshold voltage Vth of the driving transistor M3. In the period from the time T4 to a time T5, write of the data signal Vdata to the pixel circuit 500 and Vth compensation to the data signal Vdata are performed.

The selection signal S2 changes from Low to High at the time T5. At this time T5, the emission control signal Emi and the selection signal S1 are High. The transistors M2, M4, and M7 are turned OFF in accordance with the change of the selection signal S2. The transistors M1, M2, and M4 to M7 are OFF. The control signals and the transistors are maintained in these states from the time T5 to a time T6.

The emission control signal Emi changes from High to Low at the time T6 and the transistors M1 and M6 are turned from OFF to ON. The selection signals S1 and S2 are High and the transistors M2, M4, M5, and M7 remain OFF. The driving transistor M3 controls the driving current to be supplied to the OLED element E1 based on the adjusted data signal stored in the storage capacitor Cst. This means that the OLED element E1 emits light.

Next, controlling the pixel circuit 500 for deterioration evaluation of the OLED element is described. The main control circuit 21 generates display data for lighting only the pixel to be evaluated and not lighting the other pixels and sends the data to the display signal circuit 16. The main control circuit 21 can generate image data for lighting only the pixel to be evaluated and send the data to the display signal circuit 16 via the adjustment circuit 22.

The main control circuit 21 in an embodiment of this specification makes an OLED element blink by writing display data to the pixel circuit for a plurality of consecutive frames and controlling ON/OFF of the emission control transistor in the emission period of each frame, like in displaying normal image data.

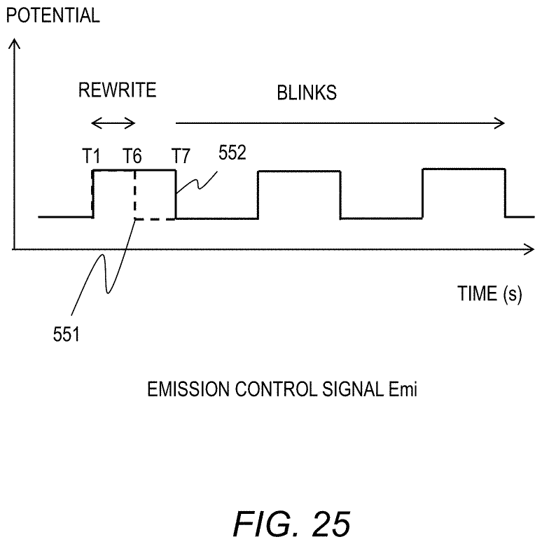

The main control circuit 21 controls the emission control signal Emi through the scanning circuit 14 in the emission period after the time T6 described with reference to FIG. 24 in one frame period to make the pixel to be evaluated blink. FIG. 25 illustrates an example of temporal variation of the emission control signal Emi for one pixel row (horizontal line) in blinking control for deterioration evaluation. The temporal variations of the other signals described with reference to FIG. 24 are the same as those in displaying normal image data.

In FIG. 25, the dashed line 551 represents the temporal variation of the emission control signal Emi in displaying normal image data. The solid line 552 represents the temporal variation of the emission control signal Emi in blinking control for deterioration evaluation. In the example of FIG. 25, the period from the time T1 to the time T7 is twice as long as the period from the time T1 to the time T6.

The times T1 and T6 are the same as the times T1 and T6 in FIG. 24. That is to say, the main control circuit 21 rewrites the data signal to the pixel circuit as described with reference to FIG. 24. Thereafter, the main control circuit 21 changes the emission control signal Emi from a High level to a Low level at the time T7. In response, the OLED element emits light.

After the time T7, the main control circuit 21 periodically changes the emission control signal Emi between a Low level and a High level. In the example of FIG. 25, a Low-level period and a High-level period have the same length, which is also equal to the length of the period from the time T1 to the time T7. In this example, the pixel circuit is in a lighting state (a state ready to light) when the emission control signal Emi is Low and in a non-lighting state when the emission control signal Emi is High. In the following description, the pulse in which the emission control signal Emi is High or an OLED element does not light (is OFF) in FIG. 25 is referred to as an off-pulse, regardless whether data is rewritten or not. Since the main control circuit 21 writes a data signal to light an OLED element only to the pixel circuit to perform measurement, only the OLED element to be evaluated blinks. Note that FIG. 25 illustrates merely an example of the cycle of blinking of an OLED element; the cycle of blinking for deterioration evaluation can be determined desirably.

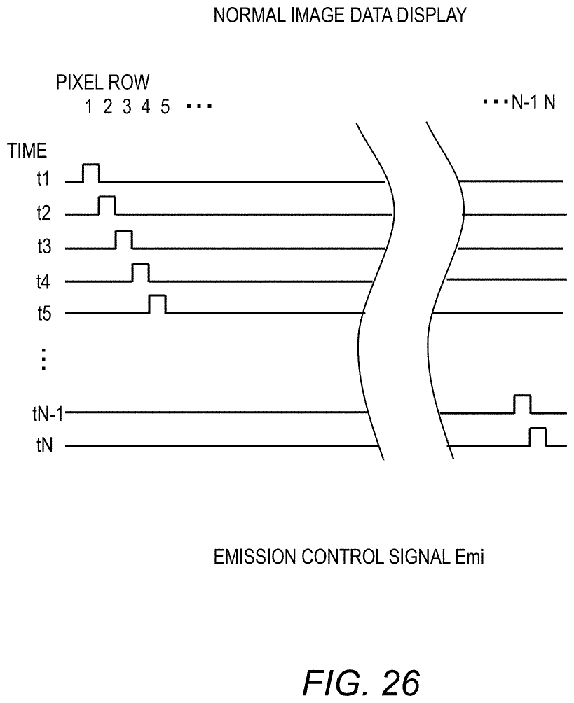

FIG. 26 illustrates an example of the emission control signals Emi for individual pixel rows at different times in displaying normal image data. At a time t1, the pixel row 1 is in a non-lighting state and the other pixel rows are in a lighting state. At the next time t2, the pixel row 2 is in a non-lighting state and the other pixel rows are in a lighting state. The pixel row in a non-lighting state is shifted forward to the next by a fixed step of Δt. FIG. 26 is provided based on the condition where the period from T1 to T6 described with FIG. 24 is equal to Δt and accordingly, each pixel row is in a non-lighting state for the period of only one step and in a lighting state during the other steps. In the case where the period from T1 to T6 is not equal to Δt, a period where adjacent pixel rows are in a non-lighting state together or all pixel rows are in a lighting state can occur.

The scanning circuit 14 can include a shift register for outputting emission control signals Emi sequentially to the pixel rows. The main control circuit 21 inputs a single pulse to the shift register in accordance with a vertical synchronizing signal corresponding to frame cycles in displaying images and further, inputs a clock signal synchronized with the horizontal synchronizing signal for selecting a pixel row to rewrite a data signal to the shift register. As a result, the emission control signals Emi illustrated in FIG. 26 are generated.

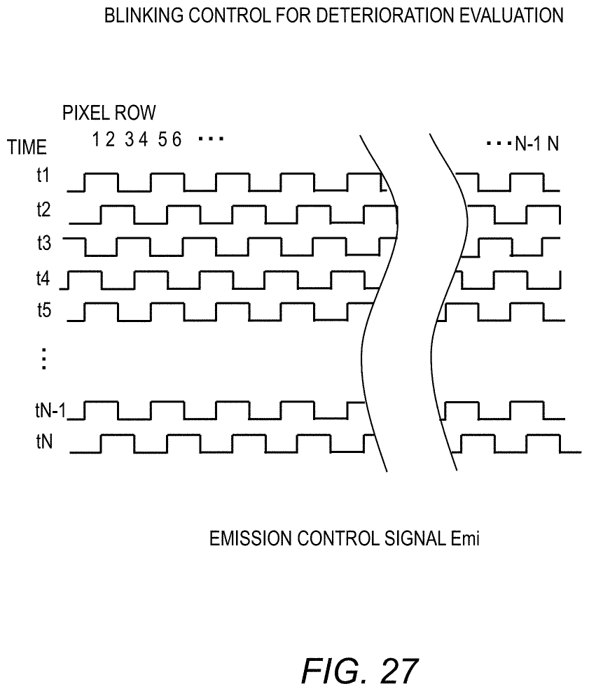

FIG. 27 illustrates an example of emission control signals Emi for individual pixel rows at different times in blinking control for deterioration evaluation. At the time t1, the pixel rows 1, 2, 5, 6, . . . are in a non-lighting state and the pixel rows 3, 4, 7, 8, . . . are in a lighting state. In this way, two pixel rows in a non-lighting state and the next two pixel rows in a lighting state are repeated. One of these pulses includes a data rewrite period in the blinking control as described with reference to FIG. 25. Configuring the interval between blinks in FIG. 27 not to be longer than the period from T1 to T6 described with FIG. 24 enables uniform (constant) blinking operation throughout the entire period. Describing an emission control signal using the cycle of an alternating signal, it can be stated that the cycle or the cycle of alternating modulation of the emission control signal is twice or more as long as the period from the time T1 to the time T6 required to rewrite data to a pixel.

At the next time t2, the pixel rows 2, 3, 6, 7, . . . are in a non-lighting state and the pixel rows 1, 4, 5, 8, 9, . . . are in a lighting state. The state at the time t2 is a state where the state at the time t1 is shifted to the next pixel row and two pixel rows in a non-lighting state and the next two pixel rows in a lighting state are repeated. The pixel rows in a non-lighting state are shifted forward to the next by a step of Δt. Focusing on one pixel row, a lighting state for the period of two steps and a non-lighting state for the period of two steps are repeated. This is the same as described with reference to FIG. 25.

An example of the main control circuit 21 keeps inputting pulses that repeat ON/OFF at intervals of two horizontal periods to the shift register in synchronization with a vertical synchronizing signal corresponding to frame cycles in displaying images. In addition, the main control circuit 21 inputs a clock signal synchronized with a horizontal synchronizing signal for selecting a pixel row for rewriting data signal to the shift register. Thus, the emission control signals Emi illustrated in FIG. 27 are generated. The intervals between blinks of the OLED elements can be changed by changing the cycle of a pulse input to the shift register.

Taking an example where the number of pixel rows (scanning lines) is 1080 and the frame frequency is 60 fps and ignoring the blanking periods between frames, one horizontal period is 15.4 μs. Because of the off-pulses for every two pixel rows as described with reference to FIGS. 25 and 27, a change between a lighting state and a non-lighting state occurs every 30.8 μs. In this case, the lighting cycle is 61.6 μs and the blinking frequency is 16.23 kHz. The above-described configuration enables an OLED element to blink at such a high frequency.

The lock-in measurement of the light intensity of an OLED element can be performed in the same way as described in the foregoing embodiments. The reference signal for the lock-in measurement can be the pulse signal input to the shift register or a series of off-pulses consisting of a plurality of off-pulses synchronized with the blinking cycles. The series of pulses can be taken out from any stage of the shift register, such as the start position or the final stage. Another example of the reference signal can be generated from the clock signal for the shift register.

The lock-in measurement of the light intensity of an OLED element can be completed within one frame period (one lighting period in normal operation) or in a period of a plurality of frame periods. The display signal for the pixel circuit is rewritten in each frame period. The main control circuit 21 controls the emission control signal Emi to changes at a fixed cycle for a plurality of frame periods so that the OLED element constantly blinks for the plurality of frame periods. If a blanking period is provided between frames, the main control circuit 21 supplies a pulse signal to the shift register not to affect the normal rewrite operation but to keep constant blinks of the OLED element during a period including the blanking periods.

The frame frequency in display control for deterioration evaluation can be the same as the frequency in displaying normal image data or can be a specific frequency different from the frequency in displaying normal image data. In displaying normal image data, one pulse (off-pulse) of the emission control signal is transferred within the shift register in one frame period, as described with reference to FIGS. 24 and 26. Each pixel row performs resetting, threshold compensation, and rewriting the display signal during the off-period and lights the OLED elements during the remaining period.

In a measurement for deterioration evaluation, a plurality of off-pulses of the emission control signal are constantly transferred within the shift register in one frame period. An off-pulse for measurement can be equal to or longer than an off-pulse required to rewrite the display signal to a pixel circuit in displaying normal images as described with reference to FIG. 25.

As described with reference to FIGS. 25 and 27, the emission control signal for the blinking control for deterioration evaluation can be composed of successive blinking control pulses by determining the off-pulse including a period for rewriting the display signal (from the time T1 to the time T6) and the off-pulse for a blink have an equal length. Since resetting, compensation, and writing can be performed within one off-pulse period, each pixel circuit can perform blinking operation for deterioration evaluation while rewriting the display signal, like in the normal displaying operation. The display signal to be rewritten in the blinking control for deterioration evaluation is unchanged. That is to say, the pixel circuit is refreshed by the same signal every frame period.

Measuring the total light intensity of a plurality of pixels in the same pixel row is available. To measure the total light intensity of pixels in a plurality of adjacent pixel rows, the main control circuit 21 generates an emission control signal so that the pixels in the pixel group to be evaluated will light together. The emission control signal is to be composed of pulse sequences to define continuous ON/OFF periods in the plurality of horizontal periods required for the aggregative measurement.

As set forth above, embodiments of this disclosure have been described; however, this disclosure is not limited to the foregoing embodiments. Those skilled in the art can easily modify, add, or convert each element in the foregoing embodiments within the scope of this disclosure. A part of the configuration of one embodiment can be replaced with a configuration of another embodiment or a configuration of an embodiment can be incorporated into a configuration of another embodiment.

What is claimed is:

1. A display device comprising:
a display panel including a plurality of pixels arrayed on a substrate;
a photosensor; and
a control device including a lock-in amplifier;
wherein each of the plurality of pixels includes a light-emitting element,
wherein the control device is configured to:
select one or more pixels from the plurality of pixels;
perform measurement of a light intensity of the one or more pixels; and
control light emission of the one or more pixels based on a result of the measurement, and
wherein the measurement includes:
applying alternating modulation to light emission of the selected one or more pixels; and
measuring a light detection signal generated by the photosensor in response to light from the selected one or more pixels with the lock-in amplifier based on a reference signal synchronized with the alternating modulation.

2. The display device according to claim 1, wherein the photosensor is disposed at a place other than the front of a display region of the display panel.

3. The display device according to claim 2, wherein the control device is configured to:
hold conversion information to calculate a frontal light intensity of the display region from the light detection signal measured by the lock-in amplifier;
convert the light detection signal measured by the lock-in amplifier into a value indicating a frontal light intensity with reference to the conversion information; and
control light emission of the one or more pixels based on the value indicating a frontal light intensity.

4. The display device according to claim 3, wherein the conversion information includes information to calculate a frontal light intensity for each of the plurality of pixels.

5. The display device according to claim 3, wherein the conversion information includes information to calculate a frontal light intensity for each of different colors.

6. The display device according to claim 1, wherein the alternating modulation is pulse modulation.

7. The display device according to claim 1,
wherein the display panel includes a common electrode to supply electric current to the light-emitting elements in the plurality of pixels, and
wherein the control device is configured to apply alternating modulation to light emission of the one or more pixels by applying alternating modulation to a potential of the common electrode.

8. The display device according to claim 1, wherein the control device is configured to apply alternating modulation to light emission of the one or more pixels by rewriting display signals stored in the one or more pixels.

9. The display device according to claim 1, further comprising:
a temperature sensor,
wherein the control device is configured to:
hold temperature compensation information to adjust the light detection signal depending on temperature; and
adjust the light detection signal based on a temperature detected by the temperature sensor and the temperature compensation information.

10. The display device according to claim 1, wherein the control device is configured to perform the measurement in an intermittent period other than displaying periods of image data.

11. The display device according to claim 10, wherein the control device is configured to:
perform the measurement on a part of the plurality of pixels in one or more intermittent periods later than the intermittent period in a case where the measurement on the part of the plurality of pixels has not been completed in the intermittent period; and
start display control of the display panel based on results of the measurement on all of the plurality of pixels after the measurement on all of the plurality of pixels is finished.

12. The display device according to claim 1,
wherein the control device is configured to perform the measurement in a case where a predetermined condition is satisfied, and
wherein the predetermined condition includes at least either one of a condition that external light incident on the display panel is weaker than a threshold and a condition that difference between temperature and a standard temperature is lower than a threshold.

13. The display device according to claim 1,
wherein the one or more pixels are a plurality of pixels, and
wherein the control device is configured to apply alternating modulation to light emission of the plurality of pixels together.

14. The display device according to claim 1,
wherein the control device is configured to:
select pixel groups each composed of a plurality of pixels one by one from the plurality of pixels; and
perform measurement of a light intensity of a selected pixel group, and
wherein the measurement of a light intensity of the pixel group includes:
applying pulse modulation to light emission of all the plurality of pixels in the pixel group together; and
performing measurement of a light intensity of each of the plurality of pixels consisting in the pixel group in a case where a result of measurement on the pixel group shows a reduction in total light intensity larger than a threshold.

15. The display device according to claim 1, wherein the control device is configured to:
perform the measurement of a light intensity of the one or more pixels for a plurality of times; and
control light emission of the one or more pixels based on a result of statistical analysis of the results of the plurality of times of measurement.

16. The display device according to claim 1, further comprising:
an optical waveguide configured to guide light emitted from the one or more pixels and leaking from regions other than the front of the display panel to the photosensor.

17. The display device according to claim 1,
wherein each of the plurality of pixels further includes an emission control transistor configured to turn ON/OFF emission of the light-emitting element, and
wherein the alternating modulation of light emission of each of the one or more pixels is performed by controlling the emission control transistor.

18. The display device according to claim 17, wherein a cycle of the alternating modulation by controlling the emission control transistor is twice or more as long as a period required to rewrite data to a pixel.

19. The display device according to claim 17, wherein a signal to be sent to control the emission control transistor is configured to change periodically for a plurality of frame periods.

20. A method of controlling a display device comprising:
selecting one or more pixels from a plurality of pixels;
measuring a light intensity of the one or more pixels; and
controlling light emission of the one or more pixels based on a result of the measurement,
wherein the measuring includes:
applying alternating modulation to light emission of the selected one or more pixels; and
performing lock-in measurement on the modulated light from the selected one or more pixels based on a reference signal synchronized with the alternating modulation.
